(19) United States
(12) Patent Application Publication
(10) Pub. No.: US 2024/0426794 A1
(43) Pub. Date: Dec. 26, 2024

(54) METHODS OF CONTROL AND ANALYSIS OF N-NITROSOCYTISINE IN CYTISINE SAMPLES

(71) Applicants: Achieve Life Sciences, Inc., Bothell, WA (US); Sopharma AD, Sofia (BG)

(72) Inventors: Nedyalko Yuriev Lesev, Sofia (BG); Vladislav Chavdarov Arabadzhiev, Sofia (BG); Nikolay Borisov Manov, Sofia (BG); Nigel Richardson, Stevenage, Hertfordshire (GB); Marco Antonio Delgado Rueda, Bucks (GB)

(21) Appl. No.: 18/742,110

(22) Filed: Jun. 13, 2024

Related U.S. Application Data
(60) Provisional application No. 63/508,298, filed on Jun. 15, 2023.

(51) Int. Cl. G01N 30/72; G01N 30/02; G01N 30/14; G01N 30/88

(52) U.S. Cl. CPC G01N 30/7233; G01N 30/14; G01N 30/88; G01N 2030/027; G01N 2030/8859

(57) ABSTRACT

Methods of detecting and analyzing N-nitrosocytisine in a cytisine sample using chromatography is provided herein. N-nitrosocytisine potentially present in the cytisine sample may be detected and analyzed using mass spectrometry.

### CROSS-REFERENCE TO RELATED APPLICATIONS

This application claims the benefit of U.S. Provisional Patent Application 63/508,298 filed Jun. 15, 2023, which is incorporated herein by reference in its entirety.

### BACKGROUND

Nicotine is an addictive substance that is rapidly absorbed during cigarette smoking. The drug distributes quickly and is thought to interact with neuronal nicotinic acetylcholine receptors (nAChRs) in the central nervous system (CNS). Nicotine addiction results, at least in part, from this interaction. Although many smokers attempt to cease smoking, few succeed without pharmacological supportive treatment.

Tobacco smoking contributes to some 7 million premature deaths each year worldwide. Smoking is highly addictive, with more than 95% of unaided attempts at cessation failing to last 6 months. It has been estimated that for every year a person continues smoking beyond his or her mid-30s, that person loses 3 months of life expectancy. The World Health Organization's Framework Convention on Tobacco Control identifies evidence-based approaches to promote smoking cessation, which include mass-media campaigns, tax increases on tobacco, and help for smokers wanting to stop.

(-)-Cytisine (cytisinicline; commonly referred to simply as cytisine) is a plant-based alkaloid isolated from seeds of Cytisus laburnum L. (Golden chain) and other plants. References herein to cytisine refer to (-)-cytisine, cytisinicline. Cytisine's mechanism of action has assisted basic pharmacologists in understanding the complex pharmacology of the various subtypes of the nicotinic acetylcholine receptor. These studies have shown that both nicotine and cytisine bind strongly and preferentially to alpha4, beta2 (α4β2) receptors that mediate the release of dopamine in the shell of the nucleus accumbens and elsewhere. This receptor subtype has been implicated in the development and maintenance of nicotine dependence and was the primary target for drugs such as varenicline.

Cytisine is associated with a number of impurities such as N-nitrosocytisine. It was recently discovered that N-nitrosamines including N-nitrosocytisine are probable human carcinogens and the U.S. Food and Drug Administration (FDA) has made clear the need for a risk assessment strategy for potential nitrosamines in any pharmaceutical product at risk for their presence. As a result, the FDA has set a limit for commercial drugs with a maximum daily dose of <1.2 g/day is 30 parts per billion (ppb) of N-nitrosamines.

Accordingly, there is a need for methods of detecting and analyzing N-nitrosocytisine potentially present in cytisine samples.

### SUMMARY

Methods for detecting and analyzing N-nitrosocytisine potentially present in a cytisine sample are provided. In some embodiments, the cytisine sample may be a cytisine drug substance, a cytisine drug product, or other mixtures containing cytisine.

In some aspects, the present technology provides a chromatographic method for detecting N-nitrosocytisine in a cytisine sample. The method comprises (a) introducing the cytisine sample to a column comprising a stationary phase, wherein the cytisine sample comprises cytisine and is known to or suspected to comprise N-nitrosocytisine; (b) applying a first mobile phase comprising a first solution and a second solution in a volume ratio of about 90:10 to about 98:2 to the column such that N-nitrosocytisine, if any, is retained on the column; (c) eluting N-nitrosocytisine, if any, by applying to the column a second mobile phase comprising the first solution and the second solution in a volume ratio of about 75:25 to about 85:15, thereby forming an analyte; and (d) detecting N-nitrosocytisine, if any, in the analyte, wherein: the first solution comprises about 0.01% (v/v) to about 0.5% (v/v) of formic acid in water; and the second solution comprises about 0.01% (v/v) to about 0.5% (v/v) of formic acid in a mixture of about 40:60 (v/v) to about 60:40 (v/v) methanol and acetonitrile.

In some embodiments, the chromatographic method further comprises mixing the cytisine sample with a solvent prior to the introduction (a). In some embodiments, the solvent is water and/or methanol.

In some embodiments, the first solution comprises 0.1% (v/v) formic acid in water.

In some embodiments, the second solution comprises 0.1% (v/v) formic acid in a mixture of 50:50 (v/v) methanol and acetonitrile.

In some embodiments, the first mobile phase comprises the first solution and the second solution in a volume ratio of about 95:5.

In some embodiments, the second mobile phase comprises the first solution and the second solution in a volume ratio of about 80:20.

In some embodiments, the first mobile phase is applied to the column for at least about 5 minutes in the application (b). In some embodiments, the first mobile phase is applied to the column for about 10 minutes in the application (b).

In some embodiments, the second mobile phase is applied to the column for at least about 2 minutes after the application (b). In some embodiments, the second mobile phase is applied to the column for about 5 minutes after the application (b).

In some embodiments, the column is a high-performance liquid chromatography (HPLC) column.

In some embodiments, the column is an ultra high-performance liquid chromatography (UPLC) column.

In some embodiments, the column is a pentafluorophenyl (PFP) column.

In some embodiments, the column is an octadecylsilyl-pentafluorophenyl (C18-PFP) column.

In some embodiments, the stationary phase has a length of about 150 mm, and an inner diameter of about 4.6 mm.

In some embodiments, the stationary phase has a length of about 100 mm, and an inner diameter of about 3.0 mm.

In some embodiments, the stationary phase comprises porous particles having a particle size of about 2.6 μm, and a pore size of about 100 Å.

In some embodiments, the stationary phase comprises porous particles having a particle size of about 1.7 μm, and a pore size of about 100 Å.

In some embodiments, N-nitrosocytisine, if any, is ionized and directed to a mass spectrometer for the detection (d), wherein N-nitrosocytisine is ionized to one or more ions detectable by the mass spectrometer. In some embodiments, N-nitrosocytisine, if any, is ionized by an electrospray ionization (ESI) source. In some embodiments, N-nitrosocytisine, if any, is ionized by an atmospheric pressure chemical ionization (APCI) source.

In some embodiments, the mass spectrometer for the detection (d) is in positive ion mode. In some embodiments, the N-nitrosocytisine is ionized to generate one or more positive ions with a mass-to-charge ratio (m/z) of about 220.11. In some embodiments, the N-nitrosocytisine is ionized to generate one or more positive ions with a mass-to-charge ratio (m/z) of 220.1081.

In some embodiments, the mass spectrometer for the detection (d) is a high-resolution mass spectrometer (HR-MS).

In some embodiments, N-nitrosocytisine, if any, is detected by quadrupole time-of-flight (Q-TOF) mass spectrometry.

In some embodiments, the cytisine sample is a drug substance. In some embodiments, the cytisine sample is mixed with water prior to the introduction (a).

In some embodiments, the cytisine sample is a drug product that optionally comprises a pharmaceutically acceptable carrier and/or excipient. In some embodiments, the drug product is in the form of tablet. In some embodiments, each tablet comprises about 1.5 mg or about 3 mg cytisine. In some embodiments, the cytisine sample is a mixture that optionally comprises a pharmaceutically acceptable carrier and/or excipient. In some embodiments, the tablet is powdered, pulverized, crushed, or ground prior to the introduction (a). In some embodiments, the cytisine sample is mixed with water and/or methanol prior to the introduction (a).

In some embodiments, the chromatographic method further comprises, subsequent to detecting the N-nitrosocytisine in the analyte, determining a content of N-nitrosocytisine in the cytisine sample via an external standard method.

In some embodiments, the chromatographic method further comprises, subsequent to detecting the N-nitrosocytisine in the analyte, determining a content of N-nitrosocytisine in the cytisine sample via an internal standard method. In some embodiments, an isotope of N-nitrosocytisine is used as an internal standard of the internal standard method. In some embodiments, the isotope of N-nitrosocytisine is N-nitrosocytisine-d4.

### BRIEF DESCRIPTION OF THE DRAWINGS

FIG. 1 is a flowchart showing an example process 100 for detecting N-nitrosocytisine in a cytisine sample in accordance with embodiments of the present technology.

FIG. 2 is an overlay of chromatograms of different samples containing, from top to bottom, water, methanol, 1 ng/mL N-nitrosocytisine in water, 1 ng/mL N-nitrosocytisine in methanol, cytisinicline 1.5 mg tablet, and cytisinicline 3 mg tablet, detected via methods in accordance with embodiments of the present technology.

FIG. 3A shows a calibration curve plot generated for determining concentration of N-nitrosocytisine in a cytisine sample (cytisine drug substance).

FIG. 3B shows a calibration curve plot generated for determining concentration of N-nitrosocytisine in a cytisine sample (cytisinicline 1.5 mg tablet).

FIG. 3C shows a calibration curve plot generated for determining concentration of N-nitrosocytisine in a cytisine sample (cytisinicline 1.5 mg tablet).

FIG. 3D shows a calibration curve plot generated for determining concentration of N-nitrosocytisine in a cytisine sample (cytisinicline 3 mg tablet).

FIG. 3E shows a calibration curve plot generated for determining concentration of N-nitrosocytisine in a cytisine sample (cytisinicline 3 mg tablet).

FIG. 4A shows a calibration curve plot generated for determining concentration of N-nitrosocytisine in a cytisine sample (cytisine drug substance). The cytisine sample was prepared and analyzed on the same day.

FIG. 4B shows a calibration curve plot generated for determining concentration of N-nitrosocytisine in a cytisine sample (cytisine drug substance). The cytisine sample was analyzed one day after it was prepared.

FIG. 4C shows a calibration curve plot generated for determining concentration of N-nitrosocytisine in a cytisine sample (cytisinicline 1.5 mg tablet). The cytisine sample was prepared and analyzed on the same day.

FIG. 4D shows a calibration curve plot generated for determining concentration of N-nitrosocytisine in a cytisine sample (cytisinicline 1.5 mg tablet). The cytisine sample was analyzed one day after it was prepared.

FIG. 4E shows a calibration curve plot generated for determining concentration of N-nitrosocytisine in a cytisine sample (cytisinicline 3 mg tablet). The cytisine sample was prepared and analyzed on the same day.

FIG. 4F shows a calibration curve plot generated for determining concentration of N-nitrosocytisine in a cytisine sample (cytisinicline 3 mg tablet). The cytisine sample was analyzed one day after it was prepared.

FIG. 5A shows the reactive site of cytisine.

FIG. 5B illustrates formation of N-nitrosocytisine from cytisine.

### DETAILED DESCRIPTION

As a cyclic secondary amine, cytisine is a nitrosable compound. As shown below, under acidic conditions, cytisine may be converted to N-nitrosocytisine in the presence of residual nitrites:

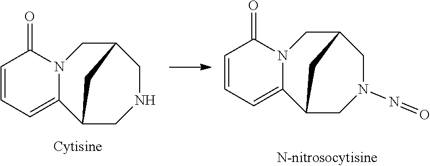 [SMILES: O=c1cccc2n1C[C@@H]1CNC[C@H]2C1 ; O=NN1C[C@@H]2C[C@H](C1)c1cccc(=O)n1C2]

As such, cytisine samples may be associated with low levels of N-nitrosocytisine, and co-elution of N-nitrosocytisine with cytisine in chromatographic separation procedures has presented challenges for assessing the clinical safety of cytisine samples.

The present technology relates to a method to detect and analyze N-nitrosocytisine in a cytisine sample. The method particularly involves the use of chromatography (e.g., gradient HPLC or UPLC method) coupled with mass spectrometry (e.g., Q-TOF) to detect and analyze N-nitrosocytisine. The mass spectrometry may be a high-resolution mass spectrometry. The mass spectrometry may be in positive ion mode. In addition, an internal standard such as an isotope of N-nitrosocytisine (e.g., N-nitrosocytisine-d4) may be used to quantitatively determine the amount of N-nitrosocytisine present in the cytisine sample.

While the present technology is capable of being embodied in various forms, the description below of several embodiments is made with the understanding that the present technology is to be considered as an exemplification of the invention and is not intended to limit the invention to the specific embodiments illustrated. Headings are provided for convenience only and are not to be construed to limit the invention in any manner. Embodiments illustrated under any heading may be combined with embodiments illustrated under any other heading.

### Definitions

The numerical values used in the various quantitative values specified in this application, unless expressly indicated otherwise, are stated as approximations as though the minimum and maximum values within the stated ranges were both preceded by the word “about.” It is to be understood, although not always explicitly stated, that all numerical designations are preceded by the term “about.” It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth. It also is to be understood, although not always explicitly stated, that the reagents described herein are merely exemplary and that equivalents of such are known in the art.

The term “about,” as used herein when referring to a measurable value such as an amount or concentration and the like, is meant to encompass variations of 20%, 10%, 5%, 1%, 0.5%, or even 0.1% of the specified amount.

The terms “mass spectrometry” and “MS” as used herein refer to methods of filtering, detecting, and measuring ions based on their mass-to-charge ratio, or “m/z.” In general, one or more molecules of interest are ionized, and the ions are subsequently introduced into a mass spectrographic instrument where, due to a combination of magnetic and electric fields, the ions follow a path in space that is dependent upon mass (“m”) and charge (“z”).

Also, the disclosure of ranges is intended as a continuous range, including every value between the minimum and maximum values recited, as well as any ranges that may be formed by such values. Also disclosed herein are any and all ratios (and ranges of any such ratios) that may be formed by dividing a disclosed numeric value into any other disclosed numeric value. Accordingly, the skilled person will appreciate that many such ratios, ranges, and ranges of ratios may be unambiguously derived from the numerical values presented herein and, in all instances, such ratios, ranges, and ranges of ratios represent various embodiments of the present technology.

### Methods

The present technology provides methods for detecting N-nitrosocytisine in a cytisine sample. The cytisine sample may be a cytisine drug substance, a cytisine drug product, or mixtures of cytisine with excipients. In some aspects, the present technology also provides methods for determining content of N-nitrosocytisine in the cytisine sample. The chromatographic methods disclosed herein achieve adequate selectivity and specificity, as well as high recovery rate for routine testing.

In some aspects, the present technology provides a chromatographic method for detecting N-nitrosocytisine in a cytisine sample. The method comprises (a) introducing the cytisine sample to a column comprising a stationary phase, wherein the cytisine sample comprises cytisine and is known to or suspected to comprise N-nitrosocytisine; (b) applying a first mobile phase comprising a first solution and a second solution in a volume ratio of about 90:10 to about 98:2 to the column such that N-nitrosocytisine, if any, is retained on the column; (c) eluting N-nitrosocytisine, if any, by applying to the column a second mobile phase comprising the first solution and the second solution in a volume ratio of about 75:25 to about 85:15, thereby forming an analyte; and (d) detecting N-nitrosocytisine, if any, in the analyte, wherein: the first solution comprises about 0.01% (v/v) to about 0.5% (v/v) of formic acid in water; and the second solution comprises about 0.01% (v/v) to about 0.5% (v/v) of formic acid in a mixture of about 40:60 (v/v) to about 60:40 (v/v) methanol and acetonitrile.

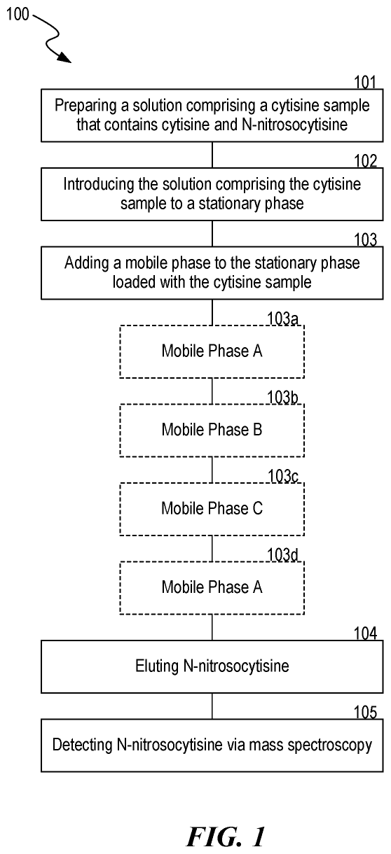

FIG. 1 is a flowchart illustrating a process 100 capable of detecting N-nitrosocytisine in a cytisine sample. At step 101, the process 100 begins with preparing a solution comprising a cytisine sample, wherein the sample includes cytisine and is known to or suspected to contain N-nitrosocytisine.

In some embodiments, the chromatographic method further comprises mixing the cytisine sample with a solvent prior to the introduction (a). Non-limiting example solvents include water, alcohols such as methanol, ethanol, n-propanol, isopropanol, n-butanol, isobutanol, and tert-butanol, ethyl acetate and other lower alkanols, glycerin, acetone, dichloromethane (DCM), dimethyl sulfoxide (DMSO), dimethylacetamide (DMA), dimethylformamide (DMF), isopropyl ether, acetonitrile, toluene, N-methylpyrrolidone (NMP), tetrahydrofuran (THF), tetrahydropyran, other cyclic mono-, di- and tri-ethers, polyalkylene glycols (e.g., polyethylene glycol, polypropylene glycol, propylene glycol), and mixtures thereof in suitable proportions. In some embodiments, the solvent is water and/or an alcohol. In some embodiments, the solvent is water. In some embodiments, the solvent is methanol.

As used herein, the term “drug substance” refers to a compound (e.g., cytisine) that is biologically active. In some embodiments, the cytisine sample is a drug substance. In some embodiments, the cytisine sample is mixed with water prior to the introduction (a).

As used herein, the term “drug product” refers to a composition that contains a drug substance (i.e., active ingredient) and optionally a pharmaceutically acceptable carrier and/or excipient. Non-limiting examples of pharmaceutically acceptable carriers and/or excipients include water, buffers, organic solvents, inorganic salts, surfactants, and polymers. In some embodiments, the cytisine sample is a drug product that optionally comprises a pharmaceutically acceptable carrier and/or excipient. In some embodiments, the drug product is in the form of a tablet, pill, capsule, powder, and the like. In some embodiments, the drug product is in the form of one or more tablets. In some embodiments, each tablet comprises about 0.5 mg to about 9 mg cytisine, about 1 mg to about 6 mg cytisine, or about 1.5 mg to about 3 mg cytisine. In some embodiments, each tablet comprises about 1.5 mg cytisine. In some embodiments, each tablet comprises about 3 mg cytisine. In some embodiments, the tablet is powdered, pulverized, crushed, or ground prior to the introduction (a). In some embodiments, the cytisine sample is mixed with water and/or methanol prior to the introduction (a).

The mixing may be performed using an agitator, a vortexer, a rotary shaker, a magnetic stirrer, a centrifugal mixer, an overhead stirrer, etc., at a speed of about 500 rpm to about 15,000 rpm, about 1,000 rpm to about 12,000 rpm, about 5,000 rpm to about 10,000 rpm, or about 9,000 rpm for an amount of time sufficient for mixing, for example, from 1 minute to 1 hour, from 5 minutes to 30 minutes, or from 10 minutes to 15 minutes.

The process 100 may continue to step 102 where the cytisine sample is introduced to a column comprising a stationary phase. In some embodiments, the stationary phase is housed in a separation column, which serves as a separation channel or chromatographic column.

In some embodiments, the chromatographic methods disclosed herein include high-performance liquid chromatography (HPLC). In some embodiments, the methods include reverse-phase high-performance liquid chromatography (RP-HPLC). In some embodiments, the column is a HPLC column.

In some embodiments, the chromatographic methods disclosed herein include ultra high-performance liquid chromatography (UPLC). In some embodiments, the methods include reverse-phase ultra high-performance liquid chromatography (RP-UPLC). In some embodiments, the column is a UPLC column.

In some embodiments, the stationary phase is a hydrophobic stationary phase.

In some embodiments, the stationary phase is a hydrophilic stationary phase.

In some embodiments, the stationary phase is a hydrophilic/hydrophobic mixed stationary phase.

In some embodiments, the column is a pentafluorophenyl (PFP) column. In some embodiments, the stationary phase is a PFP stationary phase. The PFP stationary phase may have a length of about 50 mm to about 250 mm, about 75 mm to about 200 mm, or about 100 mm to about 175 mm, and an inner diameter of about 3 mm to about 6 mm, about 4 mm to about 5 mm, or about 4.2 mm to about 4.8 mm. In some embodiments, the PFP stationary phase has a length of about 150 mm, and an inner diameter of about 4.6 mm. The PFP stationary phase may comprise porous particles having a particle size of about 1.5 μm to about 10 μm, about 2.0 μm to about 5 μm, or about 2.4 μm to about 3 μm, and a pore size of about 50 Å to about 200 Å, about 75 Å to about 150 Å, or about 90 Å to about 110 Å. In some embodiments, the PFP stationary phase comprises porous particles having a particle size of about 2.6 μm, and a pore size of about 100 Å. In one embodiment, the stationary phase is a PFP stationary phase having a length of 150 mm and an inner diameter of 4.6 mm and is packed with porous particles having a particle size of 2.6 μm and a pore size of 100 Å (PFP, 150×4.6 mm, 2.5 μm, 100 Å).

In some embodiments, the column is an octadecylsilyl-pentafluorophenyl (C18-PFP) column. In some embodiments, the stationary phase is a C18-PFP stationary phase. The C18-PFP stationary phase may have a length of about 30 mm to about 250 mm, about 50 mm to about 200 mm, or about 75 mm to about 150 mm, and an inner diameter of about 1 mm to about 6 mm, about 2 mm to about 5 mm, or about 2.5 mm to about 3.5 mm. In some embodiments, the C18-PFP stationary phase has a length of about 100 mm, and an inner diameter of about 3 mm. The C18-PFP stationary phase may comprise porous particles having a particle size of about 1 μm to about 10 μm, about 1.2 μm to about 5 μm, or about 1.5 μm to about 2 μm, and a pore size of about 50 Å to about 200 Å, about 75 Å to about 150 Å, or about 90 Å to about 110 Å. In some embodiments, the C18-PFP stationary phase comprises porous particles having a particle size of about 1.7 μm, and a pore size of about 100 Å. In one embodiment, the stationary phase is a C18-PFP stationary phase having a length of 100 mm and an inner diameter of 3 mm and is packed with porous particles having a particle size of 1.7 μm and a pore size of 100 Å (C18-PFP, 100×3 mm, 1.7 μm, 100 Å).

In some embodiments, the stationary phase is a C18 stationary phase. In another embodiment, the stationary phase is a C18 stationary phase in a column having a length of 150 mm, an inner diameter of 4.6 mm, and packed with particles having an average size 2.7 μm (C18, 150×4.6 mm, 2.7 μm). In yet another embodiment, the stationary phase is a C18 stationary phase in a column having a length of 150 mm, an inner diameter of 4.6 mm, and packed with particles having an average size 3.5 μm (C18, 150×4.6 mm, 3.5 μm). In one embodiment, the stationary phase is a C18 stationary phase in a column having a length of 150 mm, an inner diameter of 4.6 mm, and packed with particles having an average size 2.5 μm (C18, 150×4.6 mm, 2.5 μm).

The process 100 may continue to step 103 where a mobile phase is passed through the column and a polarity of the mobile phase is deliberately changed over the course of step 103 (e.g., gradient phase chromatography).

In some embodiments, the mobile phase is a two-component system comprising a first solution and a second solution to elute the cytisine sample, wherein a ratio of the first solution to the second solution changes to provide a mobile phase gradient. In some embodiments, the mobile phase is changed during step 103 to influence the retention of N-nitrosocytisine, providing optimal resolution and detection of N-nitrosocytisine potentially present in the cytisine sample.

In certain embodiments, the first and the second solutions are compatible with analytical techniques such as mass spectrometry, for example, the first and the second solutions are suitable for injection into a mass spectrometer. The mobile phases may be compatible with analytical techniques such as mass spectrometry because the mobile phases comprise volatile components. In some embodiments, the mobile phase is substantially free of “non-volatile components.” The term “non-volatile components,” used herein, refers to components present in the one or more mobile phases which are substantially non-volatile under conditions used for removing mobile phase solvents when interfacing a liquid chromatography system with a mass spectrometer.

In some embodiments, the first solution comprises about 0.01% (v/v) to about 0.5% (v/v) of formic acid in water, about 0.05% (v/v) to about 0.25% (v/v) of formic acid in water, about 0.075% (v/v) to about 0.15% (v/v) of formic acid in water, or about 0.1% (v/v) of formic acid in water.

In some embodiments, the first solution comprises 0.1% (v/v) formic acid in water.

In some embodiments, the second solution comprises about 0.01% (v/v) to about 0.5% (v/v) of formic acid, about 0.05% (v/v) to about 0.25% (v/v) of formic acid, about 0.075% (v/v) to about 0.15% (v/v) of formic acid, or about 0.1% (v/v) of formic acid in a mixture of methanol and acetonitrile. The mixture of methanol and acetonitrile comprises about 40:60 (v/v) to about 60:40 (v/v) methanol and acetonitrile, about 45:55 (v/v) to about 55:45 (v/v) methanol and acetonitrile, about 48:52 (v/v) to about 52:48 (v/v) methanol and acetonitrile, or about 50:50 (v/v) methanol and acetonitrile.

In some embodiments, the second solution comprises 0.1% (v/v) formic acid in a mixture of 50:50 (v/v) methanol and acetonitrile.

In some embodiments, the method includes (b) applying a first mobile phase comprising the first solution and the second solution in a volume ratio of about 90:10 to about 98:2 to the column such that N-nitrosocytisine, if any, is retained on the column.

Referring to FIG. 1, in some embodiments, step 103 includes a first step 103a where a first mobile phase (“Mobile Phase A” as illustrated in FIG. 1) is introduced to the column. In some embodiments, the first mobile phase comprises the first solution and the second solution in a volume ratio of about 90:10 to about 98:2, about 92:8 to about 97:3, about 94:6 to about 96:4, or about 95:5. In some embodiments, the first mobile phase comprises the first solution and the second solution in a volume ratio of about 95:5.

In some embodiments, a pH of the first mobile phase is from about 3 to about 6. For example, in some embodiments, a pH of the first mobile phase is about 3, about 4, about 5, or about 6.

In some embodiments, the first mobile phase is applied to the column for at least about 5 minutes in the application (b). In some embodiments, the first mobile phase is applied to the column for about 10 minutes in the application (b). In some embodiments, the first mobile phase is applied to the column for about 1 minute in the application (b).

In some embodiments, at step 103a, the first mobile phase is applied to (i.e., passed through) the column for at least about 1 minute. For example, in some embodiments, the first mobile phase is passed through the column for at least about 1 minute, at least about 5 minutes, at least about 6 minutes, at least about 7 minutes, at least about 8 minutes, at least about 9 minutes, at least about 10 minutes, or more.

In some embodiments, applying the first mobile phase to the column for at least about 1 minute may increase the retention of N-nitrosocytisine to the stationary phase, thereby allowing selective detection of N-nitrosocytisine in the cytisine sample. In some embodiments, applying the first mobile phase to the column for at least about 1 minute may increase the retention of N-nitrosocytisine to the stationary phase, thereby affording optimal resolution of N-nitrosocytisine from other components (e.g., cytisine) in the sample.

In some embodiments, applying the first mobile phase to the column for at least about 5 minutes may increase the retention of N-nitrosocytisine to the stationary phase, thereby allowing selective detection of N-nitrosocytisine in the cytisine sample. In some embodiments, applying the first mobile phase to the column for at least about 5 minutes may increase the retention of N-nitrosocytisine to the stationary phase, thereby affording optimal resolution of N-nitrosocytisine from other components (e.g., cytisine) in the sample.

In some embodiments, the method includes (c) eluting N-nitrosocytisine, if any, by applying to the column a second mobile phase comprising the first solution and the second solution in a volume ratio of about 75:25 to about 85:15, thereby forming an analyte.

Referring to FIG. 1, in some embodiments, step 103 includes a second step 103b where a second mobile phase (“Mobile Phase B” as illustrated in FIG. 1) is introduced to the column. In some embodiments, the second mobile phase comprises the first solution and the second solution in a volume ratio of about 75:25 to about 85:15, about 78:22 to about 82:18, about 79:21 to about 81:19, or about 80:20. In some embodiments, the second mobile phase comprises the first solution and the second solution in a volume ratio of about 80:20.

In some embodiments, a pH of the second mobile phase is from about 3 to about 6. For example, in some embodiments, a pH of the second mobile phase is about 3, about 4, about 5, or about 6.

In some embodiments, the second mobile phase is applied to the column for at least about 2 minutes after the application (b). In some embodiments, the second mobile phase is applied to the column for about 5 minutes after the application (b).

In some embodiments, at step 103b, the second mobile phase is applied to (i.e., passed through) the column for at least about 2 minutes. For example, in some embodiments, the second mobile phase is passed through the column for at least about 2 minutes, at least about 3 minutes, at least about 4 minutes, at least about 5 minutes, at least about 6 minutes, or more.

In some embodiments, step 103 includes a third step 103c where the second solution (“Mobile Phase C” as illustrated in FIG. 1, e.g., 0.1% (v/v) formic acid in a mixture of 50:50 (v/v) methanol and acetonitrile) is applied to the column to ensure elution of N-nitrosocytisine, if any, and other components (e.g., cytisine) in the sample. In some embodiments, the second solution is passes through the column for at least about 3 minutes, at least about 5 minutes, or at least about 8 minutes.

In some embodiments, step 103 includes a fourth step 103d where the first mobile phase (“Mobile Phase A” as illustrated in FIG. 1) is reintroduced to the column to restore the column for future use. In some embodiments, the first mobile phase is reintroduced into and passes through the column for at least about 0.5 minutes, at least about 1 minute, at least about 5 minutes, or at least about 10 minutes.

The process 100 may then continue to step 104 where N-nitrosocytisine is eluted from the column there by forming an analyte, wherein N-nitrosocytisine and other components (e.g., cytisine) of the sample are eluted from the column at different times so as to afford complete separation of N-nitrosocytisine. In some embodiments, N-nitrosocytisine, if present, is separated from cytisine in the sample. In some embodiments, cytisine is not present in the analyte. In some embodiments, the analyte is substantially free of cytisine. As used herein, the phrase “substantially free” refers to any cytisine that is present in an amount of less than about 0.0001%, less than about 0.001%, less than about 0.01%, less than about 0.1%, less than about 1%, or less than about 5%, relative to a total weight of the analyte.

In some embodiments, the method includes (d) detecting N-nitrosocytisine in the analyte.

Referring to FIG. 1, the process 100 may then continue to step 105 where N-nitrosocytisine in the analyte is detected. In some embodiments, the process 100 includes detecting N-nitrosocytisine in the analyte by a detector when N-nitrosocytisine is eluted from the column.

In some embodiments, the mobile phases used herein (e.g., the first and the second mobile phases) are compatible with detection techniques such as mass spectrometric analysis. In some embodiments, the mobile phases are compatible with methods of sample injection into a mass spectrometer. In some embodiments, the mobile phases are compatible with direct injection into a mass spectrometer because the mobile phases contain volatile components (e.g., the organic phase and/or the aqueous phase are volatile). In some embodiments, the acid (e.g., formic acid) present in the mobile phases is volatile and thus compatible for mass spectrometric analysis.

In some embodiments, N-nitrosocytisine, if any, is ionized and directed to a mass spectrometer for the detection (d). N-nitrosocytisine may be ionized to one or more ions detectable by the mass spectrometer. In some embodiments, the methods comprise directing N-nitrosocytisine to a mass spectrometer for detection. In some embodiments, the analyte comprising N-nitrosocytisine is injected into a mass spectrometer after elution from the column. In some embodiments, analysis of the N-nitrosocytisine after elution from the column provides a “direct” method of detecting N-nitrosocytisine and/or analyzing the content of N-nitrosocytisine.

In some embodiments, the detection technique is mass spectrometric analysis. Exemplary mass spectrometric analyzers include, but are not limited to, time-of-flight analyzers (e.g., quadrupole time of flight (Q-TOF)), ion traps analyzers (e.g., Ion Trap, Orbitrap), quadrupole analyzers (e.g., single quad, triple quad). In some embodiments, N-nitrosocytisine, if any, is detected by Q-TOF mass spectrometry.

As used herein, the term “ionization” refers to a process of producing an analyte ion having a net electrical charge equal to one or more electron units. Negative ions are those having a net negative charge of one or more electron units, while positive ions are those having a net positive charge of one or more electron units. Exemplary ionization techniques include, but are not limited to, electron ionization, chemical ionization, fast atom bombardment (FAB), matrix-assisted laser desorption ionization (MALDI), surface enhanced laser desorption ionization (SELDI), electrospray ionization (ESI), atmospheric pressure chemical ionization (APCI), atmospheric pressure photoionization (APPI), membrane introduction mass spectrometry (MIMS), and thermospray.

In some embodiments, the N-nitrosocytisine is ionized to one or more ions detectable by the mass spectrometer.

In some embodiments, N-nitrosocytisine, if any, is ionized by an ESI source.

In some embodiments, N-nitrosocytisine, if any, is ionized by an APCI source.

As used herein, the term “in positive ion mode” refers to those mass spectrometry methods where positive ions are generated and detected. The term “in negative ion mode” refers to those mass spectrometry methods where negative ions are generated and detected. In some embodiments, the mass spectrometer for the detection (d) is in positive ion mode. In some embodiments, N-nitrosocytisine is measured using ESI or APCI in positive mode.

In some embodiments, the N-nitrosocytisine is ionized to generate one or more positive ions (e.g., M+H⁺) with a mass-to-charge ratio (m/z) of 220.11±0.5, 220.11±0.4, 220.11±0.3, 220.11±0.2, 220.11±0.1, 220.11±0.05, 220.11±0.04, 220.11±0.03, 220.11±0.02, or 220.11±0.01, In some embodiments, the N-nitrosocytisine is ionized to generate one or more positive ions with a mass-to-charge ratio (m/z) of about 220.11.

In some embodiments, the mass spectrometer for the detection (d) is a high-resolution mass spectrometer.

In some embodiments, wherein the N-nitrosocytisine is ionized to generate one or more positive ions (e.g., M+H⁺) with a mass-to-charge ratio (m/z) of about 220.1070-220.1090, about 220.1072-220.1088, about 220.1074-220.1086, about 220.1076-220.1086, about 220.1078-220.1084, about 220.1080-220.1082. In some embodiments, wherein the N-nitrosocytisine is ionized to generate one or more positive ions with a mass-to-charge ratio (m/z) of about 220.1081. In some embodiments, the N-nitrosocytisine is ionized to generate one or more positive ions with a mass-to-charge ratio (m/z) of 220.1081.

In other embodiments, any of a variety of standard HPLC detectors may be used for the detection of the analyte upon elution from the analytical column. In this case, the elution of a compound from the column is detected as a peak in a chromatogram. The retention time of the peak is used to identify the compound, and the peak height (or area) is proportional to the amount of the compound in the sample. The “retention time” is the time required for an analyte to pass through a chromatographic system and is measured from the time of injection to the time of detection. Ideally, each analyte of interest will have a characteristic retention time. An appropriate detector exhibits good sensitivity, good stability, reproducibility, linear response over a few orders of magnitude, short response time, and ease of operation. Such detectors include, but are not limited to, UV/vis absorbance detectors, photodiode array detectors, fluorescence detectors, refractive index detectors, and conductivity detectors.

In some embodiments, retention times (the measure of time taken for a solute, e.g., N-nitrosocytisine, to pass through the column) of N-nitrosocytisine and other components in the sample (e.g., cytisine) are different so as to afford resolution of N-nitrosocytisine from the other components.

In some embodiments, the N-nitrosocytisine analyzed by the chromatographic method disclosed herein has a retention time of about 2 minutes to about 8 minutes, about 10 minutes to about 15 minutes, about 11 minutes to about 14 minutes, about 12 minutes to about 13 minutes, or about 6.2 minutes or 12.5 minutes. In some embodiments, the N-nitrosocytisine analyzed by the method disclosed herein has a retention time of about 6.2 minutes or about 12.5 minutes.

In some embodiments, the chromatographic method of the present technology has a limit of quantification (LoQ) for N-nitrosocytisine of about 2 ppb to about 50 ppb, about 3 ppb to about 40 ppb, or about 5 ppb to about 25 ppb.

In some embodiments, the chromatographic method of the present technology has a limit of quantification (LoQ) for N-nitrosocytisine of about 1 ppb to about 400 ppb, about 2 ppb to about 300 ppb, about 3 ppb to about 200, about 5 ppb to about 100 ppb, about 10 ppb to about 50 ppb, or about 15 ppb to about 25 ppb. In some embodiments, the LoQ for N-nitrosocytisine is about 16.7 ppb (i.e., ng/g). In some embodiments, the chromatographic method has an LoQ for N-nitrosocytisine of about 2.4 ppb (i.e., ng/g).

In some embodiments, the chromatographic method further comprises, subsequent to detecting the N-nitrosocytisine in the analyte, determining a content of N-nitrosocytisine in the cytisine sample via an external standard method.

External standard methods are generally known to a person of ordinary skill in the art. An external standard method may be developed using known data from a calibration standard (external standard curve) and unknown data from the sample to generate quantitative analysis. The external standard method may involve comparing sample peak areas (or peak heights) to those of a standard reference material. The peak areas (or peak heights) refer to detection signals obtained by detectors described above (e.g., mass spectrometer, UV/Vis absorbance detectors, fluorescence detectors). For example, the concentration of N-nitrosocytisine may be quantitatively determined by the external standard method where the peak heights of mass spectra are ascertained to determine concentrations by comparison with standard curves. As shown in Example 1 below, the standard curves may be prepared by an analogous mass spectrometric analysis of reference samples which contains known concentrations of the relevant reference standard material (i.e., N-nitrosocytisine reference material with a known purity).

In some embodiments, the chromatographic method further comprises, subsequent to detecting the N-nitrosocytisine in the analyte, determining a content of N-nitrosocytisine in the cytisine sample via an internal standard method.

Internal standard methods are generally known to a person of ordinary skill in the art. An internal standard may be used to generate a standard curve for calculating the quantity of N-nitrosocytisine. Methods of generating and using such standard curves are well known in the art and one of ordinary skill is capable of selecting an appropriate internal standard. For example, an isotope of N-nitrosocytisine may be used as an internal standard. For example, a separately detectable internal standard is provided in the sample, the amount of which is also determined in the sample. Accordingly, all or a portion of both the N-nitrosocytisine and the internal standard present in the sample is ionized to produce a plurality of ions detectable in a mass spectrometer, and one or more ions produced from each are detected by mass spectrometry.

In some embodiments, an isotope of N-nitrosocytisine is used as an internal standard of the internal standard method. In some embodiments, the isotope of N-nitrosocytisine is N-nitrosocytisine-d4.

As can be appreciated from the disclosure above, the present invention has a wide variety of applications. The invention is further illustrated by the following examples, which are only illustrative and are not intended to limit the definition and scope of the invention in any way.

### EXAMPLES

### Example 1: Analytical Method Development for the Determination of N-Nitrosocytisine in Cytisine Sample

The aim of this study was to develop an analytical HPLC method for assessing the amount of N-nitroso derivatives present in medicinal cytisine products comprising 1.5 mg and 3.0 mg of cytisine. Provided below in Tables 1-4 is a summary of the parameters screened as well as a summary of finalized system parameters optimized for the HPLC method.

### 1. Analytical Method

TABLE 1
Reagents

| | |
|---|---|
| Methanol | LC-MS grade |
| Acetonitrile | LC-MS grade |
| Formic acid | LC-MS grade |
| N-nitrosocytisine | Reference standard |

TABLE 2
Instrument Parameters

| | |
|---|---|
| HPLC | Dionex Ultimate 3000, with 10 μL Mixer and pre-Column Heater 2 μL |
| Mass spectrometer | Bruker Maxis Impact with ESI ionization source |
| Column | Phenomenex 150 × 4.60 mm Kinetex 2.6 μm PFP 100 A, PN: 00F-4477- |
| | E0 |
| Pre-Column | Phenomenex Security Guard ULTRA Cartridge PFP 4.6 mm ID, PN: |
| | AJ0-8773 |
| Mobile phase A | 0.1%(v/v) formic acid in water |
| Mobile phase B | 0.1%(v/v) formic acid in mixture of 50:50 (v:v) methanol and acetonitrile |
| Flow | 0.6 mL/min |

The Dionex Ultimate 3000 HPLC has the following parameters: pressure up to 620 bar (9,000 psi); flow rate of up to 10 mL/min; detector data collection rate up to 100 Hz; and injection cycle time as low as 15 seconds. For methods of the present technology, the Dionex Ultimate 3000 HPLC was equipped with an HPG-3400RS binary pump (max. 103 bar), with 10 μL static mixer and a WPS-3000RS Rapid Separation Well Plate Autosampler, split-loop injection type.

The Bruker Maxis Impact with ESI ionization source has the following parameters: resolution of 60,000; scan speed of 1-60 Hz (MS & MS/MS); CID fragmentation; ESI source; and size of 1200 mm×800 mm×1980 mm.

The Phenomenex 150×4.60 mm Kinetex 2.6 μm PFP 100A column has the following parameters: particle size: 2.6 μm; phase: reverse-phase; stationary phase: Kinetix PFP (core-shell bonded with pentafluorophenyl with TMS endcapping); and column size: 150×4.60 mm.

The Phenomenex Security Guard ULTRA Cartridge PFP 4.6 mm ID pre-column has the following parameters: material: PFP (pentafluorophenyl); pH stability: 1.5-8.5; and column internal diameter (ID): 4.6 mm.

TABLE 3
Gradient Program

| Time, min | Mobile phase A, % | Mobile phase B, % |
|---|---|---|
| 0 | 95 | 5 |
| 5 | 95 | 5 |
| 10 | 80 | 20 |
| 15 | 0 | 100 |
| 20 | 0 | 100 |
| 21 | 95 | 5 |
| 26 | 95 | 5 |

TABLE 4
Conditions

| | |
|---|---|
| Column temperature | 40° C. |
| Injection volume | 3 μL |

Mass-spectrometer

| | |
|---|---|
| Ionization Source | ESI positive |

Source parameters

| | |
|---|---|
| End Plate Offset | 500 V |
| Capillary | 4500 V |
| Nebulizer | 2.0 Bar |
| Dry Gas | 8.0 L/min |
| Dry Temperature | 200° C. |

Full spectra were saved. Extracted Ion Chromatogram at 220.1081 m/z was used for calculations. The m is [M+H]⁺ ions, which are detected in positive mode. The retention time of the Reference solutions was used as second identification for N-nitrosocytisine—about 12.5 min.

The system was set to direct the flow from the column into the mass-spectrometer only at the time interval of the N-nitrosocytisine.

Test solution for cytisine: 30 mg cytisine was dissolved in 1 ml of water.

Test solution for cytisinicline: To 0.103 g from powdered tablets was added 0.5 mL methanol and the solution was mixed with vortex for 1 minute. Then, the solution was centrifuged for 5 min at 9000 rpm. The supernatant was filtered through a regenerated cellulose filter with a pore size of 0.2 μm.

Reference solutions: A series of Reference solutions were prepared with concentrations between 0.5 and 250 ng/mL N-nitrosocytisine. Water was used as the solvent for the analysis of cytisine and methanol was used as the solvent for the analysis of cytisinicline.

System Suitability Test (Test for Sensitivity): Reference solutions with concentration 0.5 ng/mL were injected. Acceptance criteria: S/N ratio not less than 10. The retention time for N-nitrosocytisine was about 12.5 min.

Procedure: Reference solutions were injected and the appropriate calibration function (e.g., linear, quadratic, with or without weighing) was used to calculate the concentration of N-nitrosocytisine in Test solution for cytisine/Test solution for cytisinicline tablet. (C_{N-NOCyt}, ng/ml). The deviation of the back-calculated concentrations of the Reference solutions from the true concentration, using the calibration curve in the relevant region were not more than ±20%.

For cytisine: C_{N-NOCyt} was divided by the weighted mass of cytisine in g (0.03 g) to convert the concentration to ng N-nitrosocytisine per 1 g cytisine.

For cytisinicline: C_{N-NOCy} was multiplied by 0.5 and divide the result by the weighted mass of powdered tablets to convert the concentration in ng N-nitrosocytisine per 1 g tablet mixture.

### Calculations:

Cytisine

$$X = \frac{{C}_{N - NOC yt} , ng / mL}{{M}_{test}}$$

where:
X=content of N-Nitrosocytisine, in ppb; and
Mₜₑₛₜ=measured quantity of cytisine substance to be examined, in grams.
Cytisinicline tablet

$$X = \frac{{C}_{N - NOCyt} , ng / mL}{{M}_{test}} \times 0.5$$

where:
X=content of N-nitrosocytisine, in ppb; and
Miest=measured quantity of cytisinicline powdered tablets to be examined, in grams.

### II. Validation of the Method

Liquid chromatography—the method for determination of N-Nitrosocytisine was validated for linearity, precision of the system, accuracy, repeatability, and limit of quantification (LOQ).

### Equipment:

Liquid chromatograph: Dionex Ultimate 3000 system with MS Q-ToF detector Brucker Maxis Impact.

Balance scales: Mettler Toledo XS205 Dual Range.

Tables 5-7 provide information about reagents, reference and standard substances, and test samples used.

TABLE 5
Reagents

| | |
|---|---|
| Methanol | LC-MS grade |
| Acetonitrile | LC-MS grade |
| Formic acid | LC-MS grade |

TABLE 6
Reference and Standard Substances
N-nitrosocytisine

| | |
|---|---|
| Molecular formula | C₁₁H₁₃N₃O₂ |
| M.m: | 219.24 |
| Manufacturer | Toronto Research Chemicals, Cat # N493765 |

TABLE 7
Test Sample

| | |
|---|---|
| Cytisine active substance | Sample 1 |
| Cytisinicline 1.5 mg tb. | Sample 2A, Sample 2B |
| Cytisinicline 3 mg tb. | Sample 3 |

### 1. Selectivity

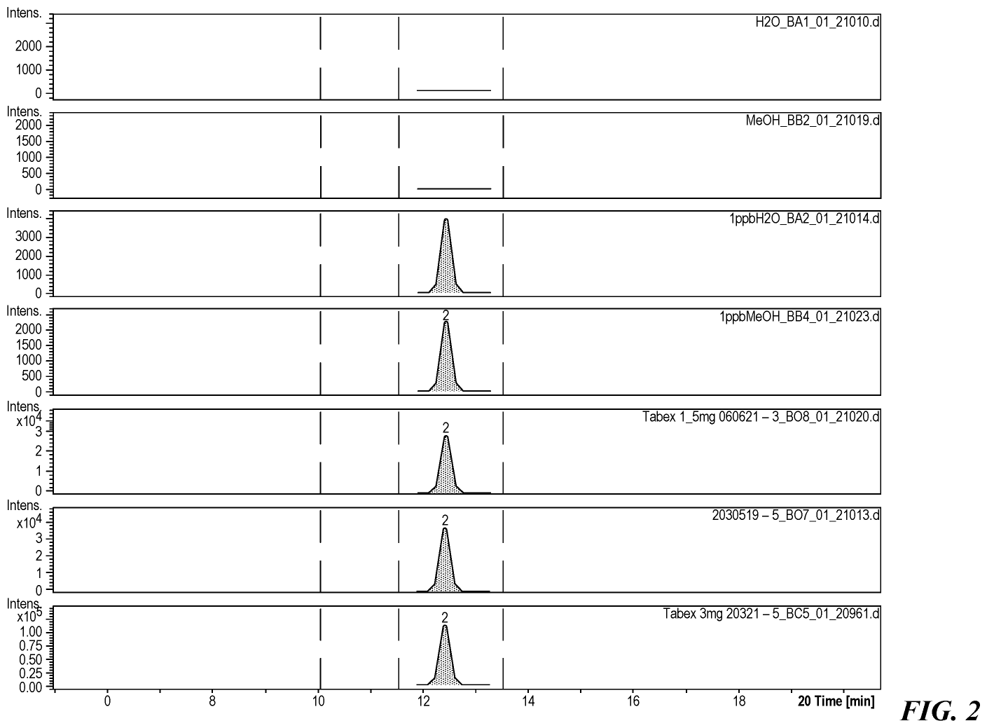

Selectivity and specificity were demonstrated by the chosen detection mode (high resolution mass spectrometry). As shown in FIG. 2, selectivity was also demonstrated by presenting chromatograms in the up to down order: water, methanol, 1 ng/mL N-nitrosocytisine in water, 1 ng/mL N-nitrosocytisine in methanol, cytisinicline 1.5 mg, cytisine, cytisinicline 3 mg.

Conclusion: There was no interference from the blank chromatograms.

### 2. Recovery and Repeatability

The validity of the method was demonstrated by spiking samples with N-nitrosocytisine at 3 concentration levels for 6 samples. The results were compared with the theoretical calculations to obtain recovery and statistical calculations for the repeatability were obtained from the 6 samples for every concentration level.

### Criteria:

Recovery rate: 70-120%
RDS≤20%

### 2.1 Results for Cytisine

Stock solution 1:5.01 mg N-nitrosocytisine (Toronto Research Chemicals, 98% purity) was dissolved in acetonitrile and diluted to 50.0 mL with the same solvent. Then, 0.102 mL of this solution was diluted to 10 mL with water (1000 ng/ml (ppb)).

Stock solution 2:2.0 mL of Stock solution 1 was diluted to 10.0 mL with water (200 ng/mL (ppb)).

Standard solution 0.5 ppb: 10.0 μL of Stock solution 1 was diluted to 10.0 mL with water. 500.0 μL of this solution was diluted with 500 μL water.

Standard solution 1 ppb: 10.0 μL of Stock solution 1 was diluted to 10.0 mL with water.

Standard solution 2 ppb: 10.0 μL of Stock solution 2 was diluted with 990 μL water.

Standard solution 5 ppb: 50.0 μL of Stock solution 1 was diluted to 10.0 mL with water.

Standard solution 10 ppb: 10.0 μL of Stock solution 1 was diluted with 990 μL water.

Standard solution 25 ppb: 25.0 μL of Stock solution 1 was diluted with 975 μL water.

Standard solution 50 ppb: 50.0 μL of Stock solution 1 was diluted with 950 μL water.

Standard solution 100 ppb: 100 μL of Stock solution 1 was diluted with 900 μL water.

Standard solution 150 ppb: 150 μL of Stock solution 1 was diluted with 850 μL water.

Standard solution 200 ppb: Used Stock solution 2.

Standard solution 250 ppb: 250 μL of Stock solution 1 was diluted with 750 μL water.

### Spiking Solutions:

Recovery Level 1: To 30 mg cytisine (Sample 1), 30.0 μL of Stock solution 2 and 970 μL water were added (6 ng/mL corresponding to 200 ng/g). Six such solutions were prepared.

Recovery Level 2: To 30 mg cytisine (Sample 1), 100 μL of Stock solution 1 and 900 μL water were added (100 ng/mL corresponding to 3.33 μg/g). Six such solutions were prepared.

Recovery Level 3: To 30 mg cytisine (Sample 1), 250 μL of Stock solution 1 and 750 μL water were added (250 ng/ml corresponding to 8.33 μg/g). Six such solutions were prepared.

Recovery Matrix: 30 mg cytisine (Sample 1), was dissolved in 1 mL water. Two such solutions were prepared.

Each spiking solution was injected 3 times. Because the cytisine samples contained N-nitrosocytisine, the calculations were corrected by subtracting the result for Recovery Matrix solution (Table 8) from Recovery Level 1, 2 and 3 solutions.

Results, shown in Table 9, were compared with the theoretical concentrations for the Recovery Level 1, 2 and 3 solutions.

TABLE 8
Results for Recovery Matrix solutions

| Solution | C, ng/mL | Ave. Concentration Matrix, ng/mL |
|---|---|---|
| Recovery Matrix 2 | 2.20 | 2.50 |
| Recovery Matrix 1 | 2.23 | |
| Recovery Matrix 2 | 2.16 | |
| Recovery Matrix 1 | 2.64 | |
| Recovery Matrix 2 | 2.59 | |
| Recovery Matrix 1 | 3.17 | |

TABLE 9
Results of cytisine sample solutions

| | | Ave. | Recovery | Average | |
|---|---|---|---|---|---|
| | | Result | per | Recovery | |
| | | per | solution, | for the | |
| | | solution, | %, | conc. | |
| Solution | Result, ng/mL | ng/mL | Corrected | level, % | RSD, % |
| Recovery Level 1-1 | 7.61 | 7.98 | 91.3 | 81.5 | 12.69 |
| Recovery Level 1-1 | 8.06 | | | | |
| Recovery Level 1-1 | 8.25 | | | | |
| Recovery Level 1-2 | 6.94 | 6.28 | 63.0 | | |
| Recovery Level 1-2 | 5.26 | | | | |
| Recovery Level 1-2 | 6.64 | | | | |
| Recovery Level 1-3 | 7.29 | 7.54 | 83.9 | | |
| Recovery Level 1-3 | 6.42 | | | | |
| Recovery Level 1-3 | 8.89 | | | | |
| Recovery Level 1-4 | 7.46 | 7.26 | 79.4 | | |
| Recovery Level 1-4 | 6.83 | | | | |
| Recovery Level 1-4 | 7.50 | | | | |
| Recovery Level 1-5 | 7.36 | 7.32 | 80.4 | | |
| Recovery Level 1-5 | 7.09 | | | | |
| Recovery Level 1-5 | 7.50 | | | | |
| Recovery Level 1-6 | 7.37 | 7.94 | 90.7 | | |
| Recovery Level 1-6 | 8.01 | | | | |
| Recovery Level 1-6 | 8.45 | | | | |
| Recovery Level 2-1 | 98.71 | 98.29 | 95.8 | 93.4 | 3.05 |
| Recovery Level 2-1 | 96.21 | | | | |
| Recovery Level 2-1 | 99.95 | | | | |
| Recovery Level 2-2 | 88.40 | 95.01 | 92.5 | | |
| Recovery Level 2-2 | 91.72 | | | | |
| Recovery Level 2-2 | 104.90 | | | | |
| Recovery Level 2-3 | 89.94 | 93.59 | 91.1 | | |
| Recovery Level 2-3 | 97.39 | | | | |
| Recovery Level 2-3 | 93.44 | | | | |
| Recovery Level 2-4 | 91.09 | 91.99 | 89.5 | | |
| Recovery Level 2-4 | 86.56 | | | | |
| Recovery Level 2-4 | 98.33 | | | | |
| Recovery Level 2-5 | 96.55 | 97.47 | 95.0 | | |
| Recovery Level 2-5 | 94.28 | | | | |
| Recovery Level 2-5 | 101.59 | | | | |
| Recovery Level 2-6 | 98.75 | 99.16 | 96.7 | | |
| Recovery Level 2-6 | 99.31 | | | | |
| Recovery Level 2-6 | 99.42 | | | | |

TABLE 9
Results of Cytisine Sample Solutions (continued)

| | | Ave. | Recovery | Average | |
|---|---|---|---|---|---|
| | | Result | per | Recovery | |
| | | per | solution, | for the | |
| | | solution, | %, | conc. | |
| Solution | Result, ng/mL | ng/mL | Corrected | level, % | RSD, % |
| Recovery Level 3-1 | 226.06 | 220.05 | 87.0 | 84.2 | 4.89 |
| Recovery Level 3-1 | 214.78 | | | | |
| Recovery Level 3-1 | 219.31 | | | | |
| Recovery Level 3-2 | 216.25 | 218.11 | 86.2 | | |
| Recovery Level 3-2 | 214.26 | | | | |
| Recovery Level 3-2 | 223.82 | | | | |
| Recovery Level 3-3 | 207.86 | 214.29 | 84.7 | | |
| Recovery Level 3-3 | 210.20 | | | | |
| Recovery Level 3-3 | 224.79 | | | | |
| Recovery Level 3-4 | 202.52 | 193.82 | 76.5 | | |
| Recovery Level 3-4 | 214.25 | | | | |
| Recovery Level 3-4 | 164.69 | | | | |
| Recovery Level 3-5 | 204.43 | 210.25 | 83.1 | | |
| Recovery Level 3-5 | 218.06 | | | | |
| Recovery Level 3-5 | 208.25 | | | | |
| Recovery Level 3-6 | 201.07 | 221.79 | 87.7 | | |
| Recovery Level 3-6 | 220.01 | | | | |
| Recovery Level 3-6 | 244.29 | | | | |

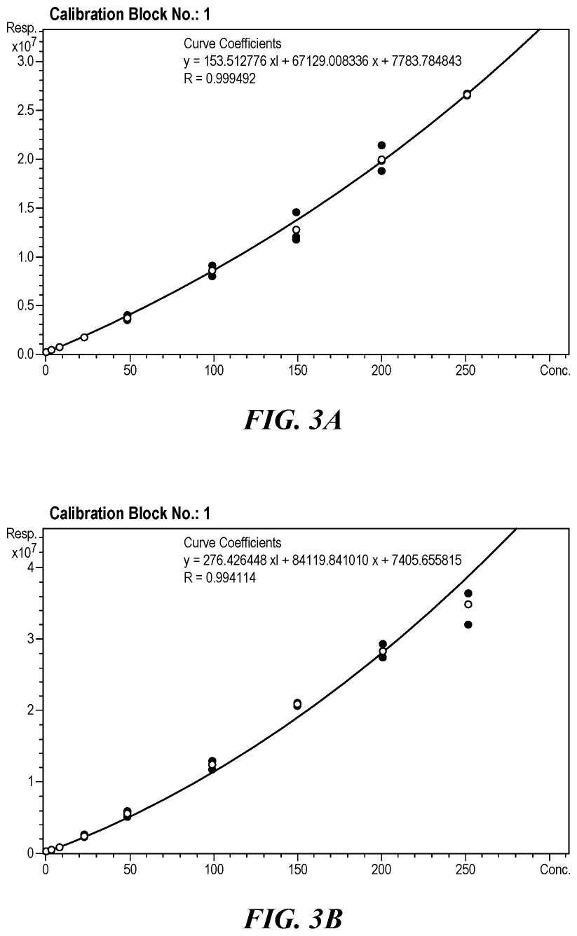

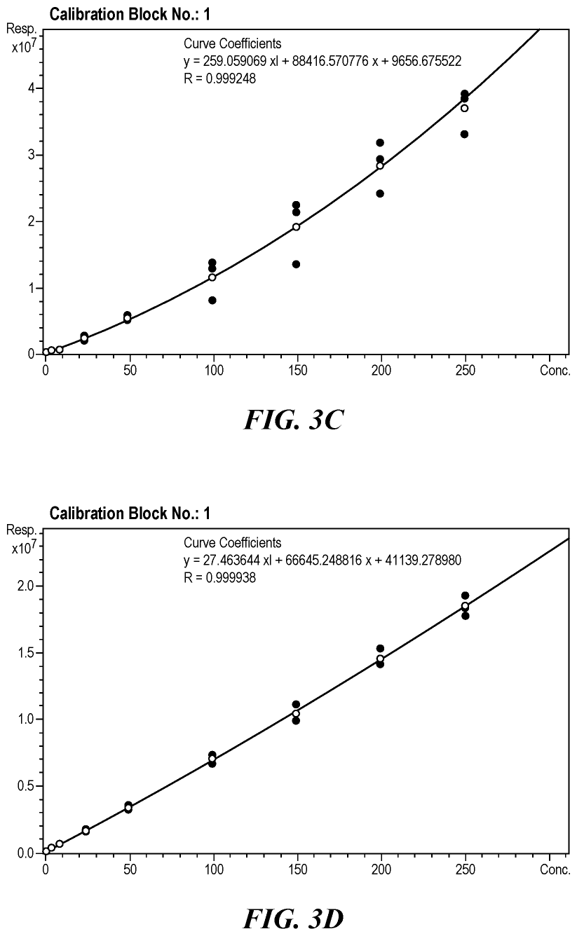

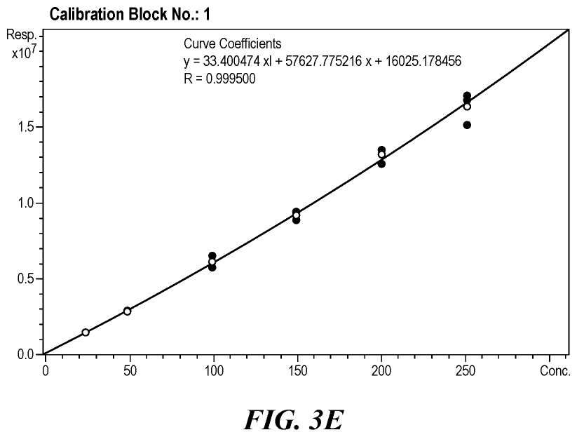

Conclusion: The obtained recovery rate and relative standard deviation for each concentration level complied with the preset criteria. FIG. 3A shows a calibration curve plot generated for the cytisine drug substance sample.

### 2.2 Results for Cytisinicline Tablet (1.5 mg)

Stock solution 1:4.54 mg N-nitrosocytisine (Toronto Research Chemicals, 98% purity) was dissolved in acetonitrile and diluted to 50.0 mL with the same solvent.

Stock solution 2:0.1125 mL of Stock solution 1 was diluted to 10 mL with methanol (1000 ng/mL (ppb)).

Stock solution 3:0.562 mL of Stock solution 1 was diluted to 10.0 mL with methanol (5000 ng/ml (ppb)).

Stock solution 4:2.2475 mL of Stock solution 1 was diluted to 10.0 mL with methanol (20 μg/mL (ppm)).

Stock solution 5:20.0 μL of Stock solution 3 was diluted to 10.0 with methanol (10 ng/ml (ppb)).

Standard solution 0.5 ppb: 50.0 μL of Stock solution 5 was diluted with 950 μL methanol.

Standard solution 1 ppb: 100.0 μL of Stock solution 5 was diluted with 900 μL methanol.

Standard solution 2 ppb: 200.0 μL of Stock solution 5 was diluted with 800 μL methanol.

Standard solution 5 ppb: 500 μL of Stock solution 5 was diluted with 500 μL methanol.

Standard solution 10 ppb: Used Stock solution 5

Standard solution 25 ppb: 25.0 μL of Stock solution 2 was diluted with 975 μL methanol.

Standard solution 50 ppb: 50.0 μL of Stock solution 2 was diluted with 950 μL methanol.

Standard solution 100 ppb: 100 μL of Stock solution 2 was diluted with 900 μL methanol.

Standard solution 150 ppb: 150 μL of Stock solution 2 was diluted with 850 μL methanol.

Standard solution 200 ppb: 200 μL of Stock solution 2 was diluted with 800 μL methanol.

Standard solution 250 ppb: 250 μL of Stock solution 2 were diluted with 750 μL methanol.

### Spiking Solutions:

Recovery Level 1: To 0.103 g powdered cytisinicline 1.5 mg (Sample 2A) 5.0 μL of Stock solution 2 was added. The mixture was left to dry at RT and 0.5 mL methanol was added (10 ng/ml corresponding to 48.5 ng/g). Then the solution was mixed by vortex for 1 minute and centrifuged for 5 min at 9000 rpm. The supernatant was filtered through a regenerated cellulose filter with a pore size of 0.2 μm. Six such solutions were prepared.

Recovery Level 2: To 0.103 g powdered cytisinicline 1.5 mg (Sample 2B) 5.0 μL of Stock solution 3 was added. The mixture was left to dry at RT and 0.5 mL methanol was added (50 ng/ml corresponding to 242.7 ng/g). Then the solution was mixed by vortex for 137319.8008.US01-168152644.1 1 minute and centrifuged for 5 min at 9000 rpm. The supernatant was filtered through a regenerated cellulose filter with a pore size of 0.2 μm. Six such solutions were prepared.

Recovery Level 3: To 0.103 g powdered cytisinicline 1.5 mg (Sample 2A) 5.0 μL of Stock solution 4 was added. The mixture was left to dry at RT and 0.5 mL methanol was added (200 ng/ml corresponding to 970 ng/g). Then the solution was mixed by vortex for 1 minute and centrifuged for 5 min at 9000 rpm. The supernatant was filtered through a regenerated cellulose filter with a pore size of 0.2 μm. Six such solutions were prepared.

Recovery Matrix: To 0.103 g powdered cytisinicline 1.5 mg (Sample 2A/2B), 0.5 mL methanol was added. The solution was mixed by vortex for 1 minute, and then centrifuged for 5 min at 9000 rpm. the supernatant was filtered through a regenerated cellulose filter with a pore size of 0.2 μm. Two such solutions were prepared for every concentration level for each sample.

Each solution was injected 3 times. Because the cytisinicline 1.5 mg sample contained N-nitrosocytisine, the calculations were corrected by subtracting the result for Recovery Matrix solution from Recovery Level 1, 2 and 3 solutions.

Results were compared with the theoretical concentrations for the Recovery Level 1, 2 and 3 solutions (Tables 10-12).

TABLE 10
Results of 1.5 mg Cytisinicline tablet samples (10 ng/mL)
Spiked 10 ng/mL

| | | Average | Average |
|---|---|---|---|
| | | result per | result for |
| | | solution, | Matrix, |
| Sample | Result, ng/mL | ng/mL | ng/mL |
| Cytisinicline Sample 2A Matrix 1 | 7.76 | 7.69 | 7.89 |
| Cytisinicline Sample 2A Matrix 1 | 7.42 | | |
| Cytisinicline Sample 2A Matrix 1 | 7.89 | | |
| Cytisinicline Sample 2A Matrix 2 | 8.43 | 8.09 | |
| Cytisinicline Sample 2A Matrix 2 | 7.86 | | |
| Cytisinicline Sample 2A Matrix 2 | 7.97 | | |

| | | Average | Corrected | |
|---|---|---|---|---|
| | | result per | Result per | |
| | | solution, | solution, | Recovery |
| Sample | Result, ng/mL | ng/mL | ng/mL | % |
| Cytisinicline Sample 2A Spiked Level | 17.54 | 17.27 | 9.38 | 93.8 |
| 1-1 | | | | |
| Cytisinicline Sample 2A Spiked Level | 17.53 | | | |
| 1-1 | | | | |
| Cytisinicline Sample 2A Spiked Level | 16.73 | | | |
| 1-1 | | | | |
| Cytisinicline Sample 2A Spiked Level | 20.26 | 19.16 | 11.27 | 112.7 |
| 1-2 | | | | |
| Cytisinicline Sample 2A Spiked Level | 18.60 | | | |
| 1-2 | | | | |
| Cytisinicline Sample 2A Spiked Level | 18.63 | | | |
| 1-2 | | | | |
| Cytisinicline Sample 2A Spiked Level | 21.45 | 19.63 | 11.74 | 117.4 |
| 1-3 | | | | |
| Cytisinicline Sample 2A Spiked Level | 18.55 | | | |
| 1-3 | | | | |
| Cytisinicline Sample 2A Spiked Level | 18.90 | | | |
| 1-3 | | | | |
| Cytisinicline Sample 2A Spiked Level | 21.38 | 20.27 | 12.38 | 123.8 |
| 1-4 | | | | |
| Cytisinicline Sample 2A Spiked Level | 18.65 | | | |
| 1-4 | | | | |
| Cytisinicline Sample 2A Spiked Level | 20.77 | | | |
| 1-4 | | | | |
| Cytisinicline Sample 2A Spiked Level | 20.37 | 19.99 | 12.10 | 121.0 |
| 1-5 | | | | |
| Cytisinicline Sample 2A Spiked Level | 18.70 | | | |
| 1-5 | | | | |
| Cytisinicline Sample 2A Spiked Level | 20.89 | | | |
| 1-5 | | | | |
| Cytisinicline Sample 2A Spiked Level | 19.70 | 19.51 | 11.62 | 116.2 |
| 1-6 | | | | |
| Cytisinicline Sample 2A Spiked Level | 18.30 | | | |
| 1-6 | | | | |
| Cytisinicline Sample 2A Spiked Level | 20.52 | | | |
| 1-6 | | | | |

| | |
|---|---|
| Average Recovery for Level 1= | 114.2 |
| RSD= | 9.36 |

TABLE 11
Results of 1.5 mg Cytisinicline tablet samples (50 ng/mL)
Spiked 50 ng/mL

| | | Average | Average |
|---|---|---|---|
| | | result per | result for |
| | | solution, | Matrix, |
| Sample | Result, ng/mL | ng/mL | ng/mL |
| Cytisinicline Sample 2A Matrix 3 | 9.36 | 8.42 | 8.35 |
| Cytisinicline Sample 2A Matrix 3 | 6.97 | | |
| Cytisinicline Sample 2A Matrix 3 | 8.93 | | |
| Cytisinicline Sample 2A Matrix 4 | 8.89 | 8.29 | |
| Cytisinicline Sample 2A Matrix 4 | 7.44 | | |
| Cytisinicline Sample 2A Matrix 4 | 8.53 | | |

| | | Average | Corrected | |
|---|---|---|---|---|
| | | result per | Result per | |
| | | solution, | solution, | Recovery, |
| Sample | Result, ng/mL | ng/mL | ng/mL | % |
| Cytisinicline Sample 2A Spiked Level | 50.33 | 48.72 | 40.37 | 80.7 |
| 2-1 | | | | |
| Cytisinicline Sample 2A Spiked Level | 45.76 | | | |
| 2-1 | | | | |
| Cytisinicline Sample 2A Spiked Level | 50.08 | | | |
| 2-1 | | | | |
| Cytisinicline Sample 2A Spiked Level | 54.43 | 45.74 | 37.39 | 74.8 |
| 2-2 | | | | |
| Cytisinicline Sample 2A Spiked Level | 42.78 | | | |
| 2-2 | | | | |
| Cytisinicline Sample 2A Spiked Level | 40.00 | | | |
| 2-2 | | | | |
| Cytisinicline Sample 2A Spiked Level | 59.65 | 48.32 | 48.32 | 96.6 |
| 2-3 | | | | |
| Cytisinicline Sample 2A Spiked Level | 40.70 | | | |
| 2-3 | | | | |
| Cytisinicline Sample 2A Spiked Level | 44.62 | | | |
| 2-3 | | | | |
| Cytisinicline Sample 2A Spiked Level | 47.23 | 47.50 | 39.15 | 78.3 |
| 2-4 | | | | |
| Cytisinicline Sample 2A Spiked Level | 49.98 | | | |
| 2-4 | | | | |
| Cytisinicline Sample 2A Spiked Level | 45.30 | | | |
| 2-4 | | | | |
| Cytisinicline Sample 2A Spiked Level | 49.11 | 48.93 | 40.58 | 81.2 |
| 2-5 | | | | |
| Cytisinicline Sample 2A Spiked Level | 54.14 | | | |
| 2-5 | | | | |
| Cytisinicline Sample 2A Spiked Level | 43.54 | | | |
| 2-5 | | | | |
| Cytisinicline Sample 2A Spiked Level | 48.55 | | | |
| 2-6 | | | | |
| Cytisinicline Sample 2A Spiked Level | 51.32 | | | |
| 2-6 | | | | |
| Cytisinicline Sample 2A Spiked Level | 47.10 | | | |

| | | |
|---|---|---|
| 2-6 | Average Recovery for Level 2= | 82.2 |
| | RSD= | 9.13 |

TABLE 12
Results of 1.5 mg Cytisinicline tablet samples (200 ng/mL) Spiked 200 ng/mL

| | | Average | Average |
|---|---|---|---|
| | | result per | result for |
| | | solution, | Matrix, |
| Sample | Result, ng/mL | ng/mL | ng/mL |
| Cytisinicline Sample 2B Matrix 1 | 18.51 | 16.93 | 19.91 |
| Cytisinicline Sample 2B Matrix 1 | 16.84 | | |
| Cytisinicline Sample 2B Matrix 1 | 15.43 | | |
| Cytisinicline Sample 2B Matrix 2 | 19.30 | 22.89 | |
| Cytisinicline Sample 2B Matrix 2 | 23.99 | | |
| Cytisinicline Sample 2B Matrix 2 | 25.39 | | |

| | | Average | Corrected | |
|---|---|---|---|---|
| | | result per | Result per | |
| | | solution, | solution, | |
| Sample | Result, ng/mL | ng/mL | ng/mL | % |
| Cytisinicline Sample 2B Spiked Level | 211.35 | 188.76 | 168.85 | 84.4 |
| 3-1 | | | | |
| Cytisinicline Sample 2B Spiked Level | 159.24 | | | |
| 3-1 | | | | |
| Cytisinicline Sample 2B Spiked Level | 195.69 | | | |
| 3-1 | | | | |
| Cytisinicline Sample 2B Spiked Level | 228.52 | 246.36 | 226.45 | 113.2 |
| 3-2 | | | | |
| Cytisinicline Sample 2B Spiked Level | 263.44 | | | |
| 3-2 | | | | |
| Cytisinicline Sample 2B Spiked Level | 247.11 | | | |
| 3-2 | | | | |
| Cytisinicline Sample 2B Spiked Level | 224.99 | 215.52 | 195.61 | 97.8 |
| 3-3 | | | | |
| Cytisinicline Sample 2B Spiked Level | 226.39 | | | |
| 3-3 | | | | |
| Cytisinicline Sample 2B Spiked Level | 195.19 | | | |
| 3-3 | | | | |
| Cytisinicline Sample 2B Spiked Level | 198.02 | 198.48 | 178.57 | 89.3 |
| 3-4 | | | | |
| Cytisinicline Sample 2B Spiked Level | 218.65 | | | |
| 3-4 | | | | |
| Cytisinicline Sample 2B Spiked Level | 178.75 | | | |
| 3-4 | | | | |
| Cytisinicline Sample 2B Spiked Level | 226.05 | 207.53 | 187.62 | 93.8 |
| 3-5 | | | | |
| Cytisinicline Sample 2B Spiked Level | 210.22 | | | |
| 3-5 | | | | |
| Cytisinicline Sample 2B Spiked Level | 186.30 | | | |
| 3-5 | | | | |
| Cytisinicline Sample 2B Spiked Level | 218.47 | 206.55 | 186.64 | 93.3 |
| 3-6 | | | | |
| Cytisinicline Sample 2B Spiked Level | 221.68 | | | |
| 3-6 | | | | |
| Cytisinicline Sample 2B Spiked Level | 179.51 | | | |

| | | |
|---|---|---|
| 3-6 | Average Recovery for Level 3= | 95.3 |
| | RSD= | 10.36 |

Conclusion: All results met the preset criteria. FIGS. 3B and 3C show calibration curve plots generated for the cytisine 1.5 mg tablet.

### 2.3 Results for Cytisinicline Tablet (3 mg)

Stock solution 1:5.68 mg N-nitrosocytisine (Toronto Research Chemicals, 98% purity) was dissolved in acetonitrile and diluted to 50.0 mL with the same solvent.

Stock solution 2:0.0898 mL of Stock solution 1 was diluted to 10 mL with methanol (1000 ng/ml [ppb]).

Stock solution 3:0.10 mL of Stock solution 2 was diluted to 10.0 mL with methanol (100 ng/ml [ppb]).

Standard solution 0.5 ppb: 50.0 μL of Stock solution 2 was diluted with 950 μL methanol.

Standard solution 1 ppb: 100.0 μL of Stock solution 2 was diluted with 900 μL methanol.

Standard solution 2 ppb: 200.0 μL of Stock solution 2 was diluted with 800 μL methanol.

Standard solution 5 ppb: 500 μL of Stock solution 2 was diluted with 500 μL methanol.

Standard solution 10 ppb: Used Stock solution 2

Standard solution 25 ppb: 0.25 mL of Stock solution 1 was diluted to 10.0 mL with methanol.

Standard solution 50 ppb: 50.0 μL of Stock solution 1 was diluted with 950 μL methanol.

Standard solution 100 ppb: 0.100 mL of Stock solution 1 was diluted to 10.0 mL with methanol.

Standard solution 150 ppb: 0.150 mL of Stock solution 1 was diluted to 10.0 mL with methanol.

Standard solution 200 ppb: 200 μL of Stock solution 1 was diluted with 800 μL methanol.

Standard solution 250 ppb: 250 μL of Stock solution 1 was diluted with 750 μL methanol.

### Spiking Solutions:

Recovery Level 1: To 0.103 g powdered cytisinicline 3 mg (Sample 3) 0.5 mL Standard solution 25 ppb was added (25 ng/ml corresponding to 121.4 ng/g). Then the solution was mixed by vortex for 1 minute and centrifuged for 5 min at 9000 rpm. The supernatant was filtered through a regenerated cellulose filter with a pore size of 0.2 μm. Six such solutions were prepared.

Recovery Level 2: To 0.103 g powdered cytisinicline 3 mg (Sample 3) 0.5 mL Standard solution 100 ppb was added (100 ng/ml corresponding to 485.4 ng/g). Then the solution was mixed by vortex for 1 minute and centrifuged for 5 min at 9000 rpm. The supernatant was filtered through a regenerated cellulose filter with a pore size of 0.2 μm. Six such solutions were prepared.

Recovery Level 3: To 0.103 g powdered cytisinicline 3 mg (Sample 3) 0.5 mL Standard solution 150 ppb was added (150 ng/ml corresponding to 728.2 ng/g). Then the solution was mixed by vortex for 1 minute and centrifuged for 5 min at 9000 rpm. The supernatant was filtered through a regenerated cellulose filter with a pore size of 0.2 μm. Six such solutions were prepared.

Recovery Matrix: To 0.103 g powdered cytisinicline 3 mg (Sample 3) 0.5 mL methanol was added. The solution was mixed by vortex for 1 minute and centrifuged for 5 min at 9000 rpm. The supernatant was filtered through a regenerated cellulose filter with a pore size of 0.2 μm. Two such solutions were prepared for every concentration level for corresponding batch.

Each solution was injected 3 times. Because the cytisinicline 3 mg sample contained N-nitrosocytisine, the calculations were corrected by subtracting the result for Recovery Matrix solution from Recovery Level 1,2 and 3 solutions.

Results were compared with the theoretical concentrations for the Recovery Level 1,2 and 3 solutions (Tables 13-16).

TABLE 13
Results of 3.0 mg Cytisinicline sample solutions
Results for Recovery Matrix solutions

| | | Average | Average |
|---|---|---|---|
| | | result per | result for |
| | | solution, | Matrix, |
| Sample | Result, ng/mL | ng/mL | ng/mL |
| Recovery Matrix 1 | 30.99 | 29.79 | 29.72 |
| Recovery Matrix 1 | 29.68 | | |
| Recovery Matrix 1 | 28.69 | | |
| Recovery Matrix 2 | 30.63 | 29.70 | |
| Recovery Matrix 2 | 29.84 | | |
| Recovery Matrix 2 | 28.63 | | |
| Recovery Matrix 3 | 29.71 | 29.66 | |
| Recovery Matrix 3 | 29.11 | | |
| Recovery Matrix 3 | 30.15 | | |

TABLE 14
Results of 3.0 mg Cytisinicline sample solutions (10 ng/mL)
Spiked 10 ng/mL

| | | Average | Corrected | |
|---|---|---|---|---|
| | | result per | Result per | |
| | Result, | solution, | solution, | Recovery, |
| Sample | ng/mL | ng/mL | ng/mL | % |
| Recovery Level 1 - 1 | 56.51 | 55.83 | 26.11 | 104.4 |
| Recovery Level 1 - 1 | 55.55 | | | |
| Recovery Level 1 - 1 | 55.42 | | | |
| Recovery Level 1 - 2 | 59.07 | 58.57 | 28.86 | 115.4 |
| Recovery Level 1 - 2 | 59.16 | | | |
| Recovery Level 1 - 2 | 57.49 | | | |
| Recovery Level 1 - 3 | 58.04 | 57.63 | 27.92 | 111.7 |
| Recovery Level 1 - 3 | 57.71 | | | |
| Recovery Level 1 - 3 | 57.16 | | | |
| Recovery Level 1 - 4 | 57.12 | 56.51 | 26.79 | 107.2 |
| Recovery Level 1 - 4 | 55.68 | | | |
| Recovery Level 1 - 4 | 56.72 | | | |
| Recovery Level 1 - 5 | 55.36 | 54.92 | 25.20 | 100.8 |
| Recovery Level 1 - 5 | 54.20 | | | |
| Recovery Level 1 - 5 | 55.20 | | | |
| Recovery Level 1 - 6 | 57.02 | 57.98 | 28.26 | 113.0 |
| Recovery Level 1 - 6 | 56.05 | | | |
| Recovery Level 1 - 6 | 60.86 | | | |

| | |
|---|---|
| Average Recovery for Level 1= | 108.8 |
| RSD= | 5.13 |

TABLE 15
Results of 3.0 mg Cytisinicline sample solutions (100 ng/mL)
Spiked 100 ng/mL

| | | Average | Corrected | |
|---|---|---|---|---|
| | | result per | Result per | |
| | Result, | solution, | solution, | Recovery, |
| Sample | ng/mL | ng/mL | ng/mL | % |
| Recovery Level 2 - 1 | 137.25 | 139.12 | 109.40 | 109.4 |
| Recovery Level 2 - 1 | 139.12 | | | |
| Recovery Level 2 - 1 | 140.98 | | | |
| Recovery Level 2 - 2 | 138.23 | 142.98 | 113.26 | 113.3 |
| Recovery Level 2 - 2 | 139.66 | | | |
| Recovery Level 2 - 2 | 151.06 | | | |
| Recovery Level 2 - 3 | 135.85 | 130.68 | 100.97 | 101.0 |
| Recovery Level 2 - 3 | 137.14 | | | |
| Recovery Level 2 - 3 | 119.06 | | | |
| Recovery Level 2 - 4 | 134.57 | 139.74 | 110.03 | 110.0 |
| Recovery Level 2 - 4 | 135.93 | | | |
| Recovery Level 2 - 4 | 148.73 | | | |
| Recovery Level 2 - 5 | 136.11 | 140.28 | 110.57 | 110.6 |
| Recovery Level 2 - 5 | 134.03 | | | |
| Recovery Level 2 - 5 | 150.72 | | | |
| Recovery Level 2 - 6 | 137.22 | 143.53 | 113.82 | 113.8 |
| Recovery Level 2 - 6 | 138.75 | | | |
| Recovery Level 2 - 6 | 154.63 | | | |

| | |
|---|---|
| Average Recovery for Level 2= | 109.7 |
| RSD= | 4.21 |

TABLE 16
Results of 3.0 mg Cytisinicline sample solutions (150 ng/mL)
Spiked 150 ng/mL

| | | Average | Corrected | |
|---|---|---|---|---|
| | | result per | Result per | |
| | Result, | solution, | solution, | Recovery, |
| Sample | ng/mL | ng/mL | ng/mL | % |
| Recovery Level 3 - 1 | 178.20 | 169.48 | 169.48 | 93.2 |
| Recovery Level 3 - 1 | 160.49 | | | |
| Recovery Level 3 - 1 | 169.76 | | | |
| Recovery Level 3 - 2 | 172.42 | 174.53 | 174.53 | 96.5 |
| Recovery Level 3 - 2 | 177.50 | | | |
| Recovery Level 3 - 2 | 173.69 | | | |
| Recovery Level 3 - 3 | 167.95 | 168.15 | 168.15 | 92.3 |
| Recovery Level 3 - 3 | 173.22 | | | |
| Recovery Level 3 - 3 | 163.27 | | | |
| Recovery Level 3 - 4 | 177.88 | 170.79 | 170.79 | 94.0 |
| Recovery Level 3 - 4 | 171.67 | | | |
| Recovery Level 3 - 4 | 162.82 | | | |
| Recovery Level 3 - 5 | 178.62 | 168.62 | 168.62 | 92.6 |
| Recovery Level 3 - 5 | 172.58 | | | |
| Recovery Level 3 - 5 | 154.67 | | | |
| Recovery Level 3 - 6 | 170.16 | 165.14 | 165.14 | 90.3 |
| Recovery Level 3 - 6 | 164.99 | | | |
| Recovery Level 3 - 6 | 160.26 | | | |

| | |
|---|---|
| Average Recovery for Level 3 = | 93.2 |
| RSD= | 2.21 |

Conclusion: All results met the preset criteria. FIGS. 3D and 3E show calibration curve plots generated for the cytisine 3.0 mg tablet.

### 3. Intermediate Precision:

### 3.1 Results for Cytisine

Three samples from Sample 1 of cytisine were prepared and analyzed on Day 1 and another three on Day 2. The results, shown in Table 17, from the two days were compared by RSD and F-test (Table 18).

### Criteria:

RSD of all results from the two days≤20%
F-Test: F≤F critical

TABLE 17
Results for Cytisine

| Results Day 1 | Results Day 2 |
|---|---|
| 339.74 | 278.49 |
| 301.99 | 264.63 |
| 304.33 | 253.28 |
| 264.72 | 317.20 |
| 316.79 | 255.78 |
| 290.18 | 260.02 |
| 306.59 | 308.99 |
| 339.27 | 256.40 |
| 279.93 | 295.38 |
| Average all results | 290.76 |
| SD all results | 28.1 |
| RSD all results | 9.67 |

TABLE 18
F-Test Two-Sample for Variances

| | Variable 1 | Variable 2 |
|---|---|---|
| Mean | 304.8378 | 276.6856 |
| Variance | 625.3401 | 607.1474 |
| Observations | 9 | 9 |
| df | 8 | 8 |
| F | 1.029964 | |
| P(F <= f) one-tail | 0.483859 | |
| F Critical one-tail | 3.438101 | |

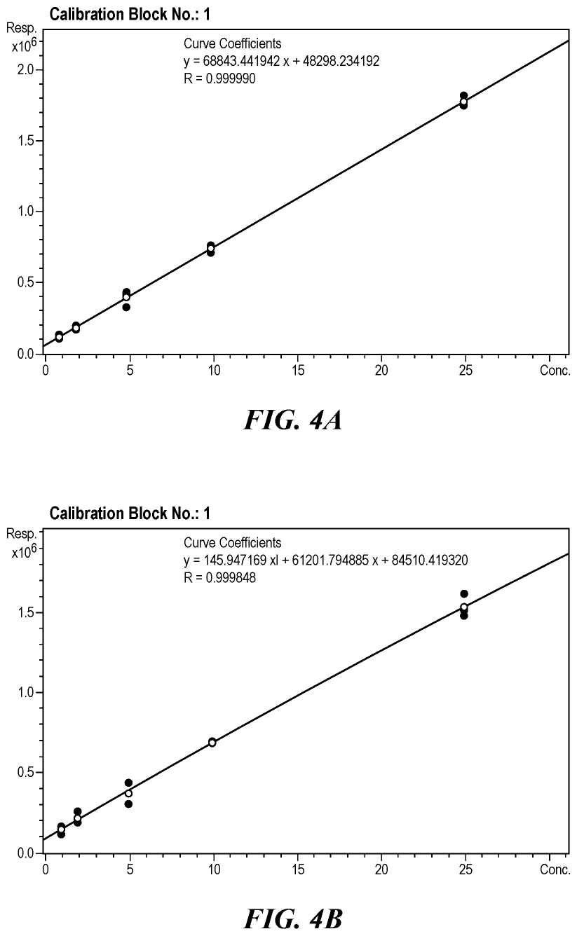

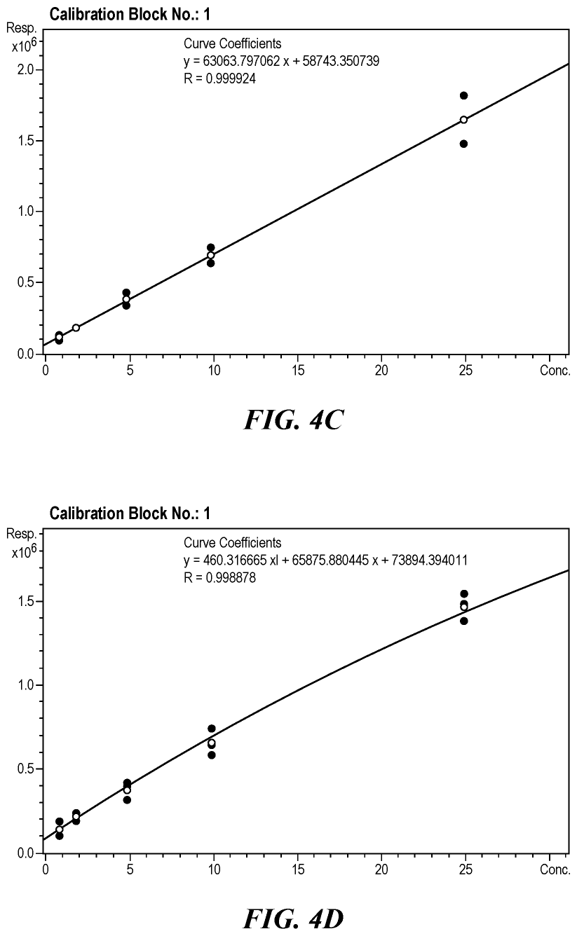

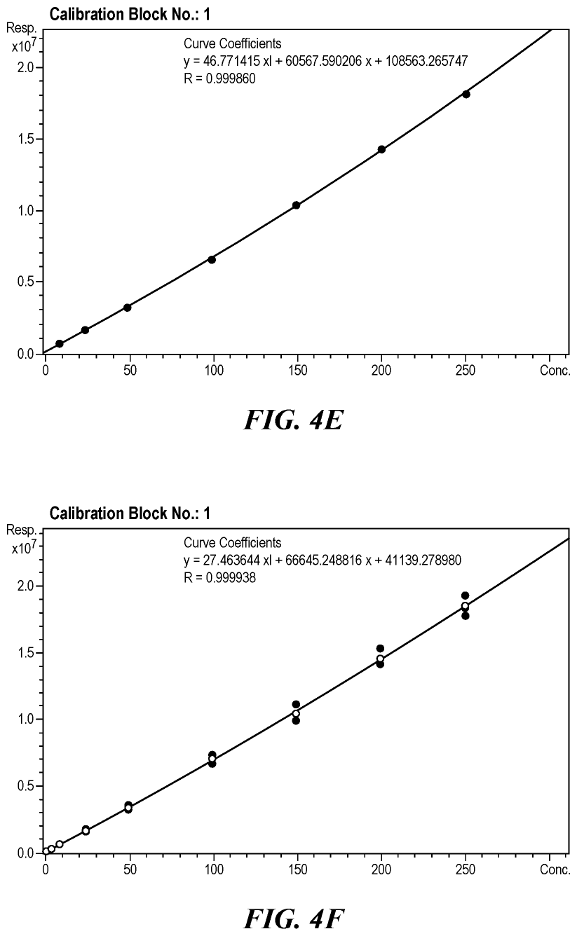

Conclusion: All results met the preset criteria. FIGS. 4A and 4B show calibration curve plots generated for the cytisine drug substance sample on day one and day two, respectively.

### 3.2 Results for Cytisinicline (1.5 mg)

Three samples from Sample 2A/2B of cytisinicline 1.5 mg were prepared and analyzed on Day 1 and another three on Day 2. The results, shown in Table 19, from the two days were compared by RSD and F-test (Table 20).

### Criteria:

RSD of all Results from the two days≤20%
F-Test: F≤F critical

TABLE 19
Results for 1.5 mg Cytisinicline

| Results Day 1 | Results Day 2 |
|---|---|
| 37.12 | 30.78 |
| 44.08 | 30.35 |
| 43.77 | 32.78 |
| 36.34 | 36.55 |
| 40.84 | 31.80 |
| 42.49 | 28.35 |
| 35.62 | 36.62 |
| 42.20 | 26.73 |
| 40.04 | 32.03 |
| Average all results | 36.03 |
| SD all results | 5.40 |
| RSD all results | 14.99 |

TABLE 20
F-Test Two-Sample for Variances

| | Variable 1 | Variable 2 |
|---|---|---|
| Mean | 31.77667 | 40.27778 |
| Variance | 10.9442 | 10.34832 |
| Observations | 9 | 9 |
| df | 8 | 8 |
| F | 1.057582 | |
| P(F <= f) one-tail | 0.469415 | |
| F Critical one-tail | 3.438101 | |

Conclusion: All results met the preset criteria. FIGS. 4C and 4D show calibration curve plots generated for the cytisine 1.5 mg tablet on day one and day two, respectively.

### 3.3 Results for Cytisinicline (3.0 mg)

Three samples from Sample 3 of cytisinicline 3.0 mg were prepared and analyzed. On day 2 the same batch of cytisinicline 3.0 mg was used for recovery studies and 3 more samples were analyzed as Recovery Matrix solutions. The results, shown in Table 21, from the two days were compared by F-test (Table 22).

### Criteria:

RSD of all Results from the two days≤20%
F-Test F≤F critical

TABLE 21
Results for 3.0 mg Cytisinicline

| Results Day 1 | Results Day 2 |
|---|---|
| 137.36 | 149.87 |
| 139.33 | 143.54 |
| 136.91 | 138.76 |
| | 148.56 |
| | 144.72 |
| | 138.83 |
| | 144.25 |
| | 141.32 |
| | 146.34 |
| Average all results | 142.48 |
| SD all results | 4.38 |
| RSD all results | 3.08 |

TABLE 22
F-Test Two-Sample for Variances

| | Variable 1 | Variable 2 |
|---|---|---|
| Mean | 144.0211 | 137.8667 |
| Variance | 15.36044 | 1.656633 |
| Observations | 9 | 3 |
| df | 8 | 2 |
| F | 9.27208 | |
| P(F <= f) one-tail | 0.100955 | |
| F Critical one-tail | 19.37099 | |

Conclusion: All results met the preset criteria. FIGS. 4E and 4F show calibration curve plots generated for the cytisine 3.0 mg tablet on day one and day two, respectively.

### 4. Limit of Quantification (LOQ)

Since N-nitrosocytisine free samples of cytisine and cytisinicline tablets were not available, LOQ was determined based on the signal for the lowest concentration level 0.5 ppb from linearity.

TABLE 23
LOQ for cytisine and Cytisinicline samples

| | Area |
|---|---|
| | N-Nitrosocytisine |
| No | 0.5 ppb solution |
| 1 | 49738 |
| 2 | 61966 |
| 3 | 42770 |
| 4 | 49872 |
| 5 | 45806 |
| 6 | 62608 |
| Av | 52126,67 |
| SD | 8306,12 |
| RSD | 15,93 |

The LOQ for cytisine was 16.7 ng/g (ppb) and the LOQ for cytisinicline tablet was 2.4 ng/g (ppb)

Conclusion: The described HPLC-MS method for determination of N-Nitrosocytisine is specific, linear, accurate and precise. The method may be used for routine testing.

### Example 2-Determination of N-nitrosocytisine Contents in Cytisine Drug Substance and Drug Product

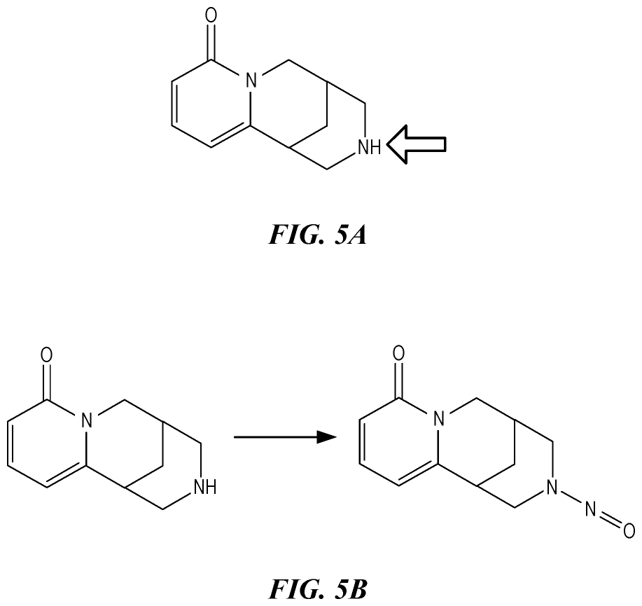

This example illustrates determination of N-nitrosocytisine in cytisine drug substance, and cytisine drug product (cytisinicline 1.5 mg tablet and cytisinicline 3.0 mg tablet). FIG. 5A show the reactive site of cytisine and the formation of N-nitrosocytisine from cytisine, respectively.

N-nitrosocytisine is commercially available and may be used as a standard material for assay determination. As described in detail in Example 1, a LC-MS (Q-TOF) method for determination of N-Nitrosocytisine has been developed and validated. Accordingly, N-nitrosocytisine content has been determined in several batches of cytisine, cytisinicline 1.5 mg film-coated tablet (fct), and cytisinicline 3.0 mg fct:

TABLE 24
N-Nitrosocytisine content in Drug Substance

| | Technological | Manufacturing | N-nitrosocytisine |
|---|---|---|---|
| No | Process | date/Testing date | content (ppb)* |
| 1 | NA | April 2017/August 2020 | <16.5 |
| 2 | NA | March 2018/August 2020 | 89.9 |
| 3 | NA | April 2019/August 2020 | 59.3 |
| 4 | NA | April 2019/August 2020 | 86.0 |
| 5 | NA | April 2019/August 2020 | 70.2 |
| 6 | NA | April 2019/August 2020 | 77.0 |
| 7 | NA | April 2019/August 2020 | 56.8 |
| 8 | NA | April 2019/August 2020 | 65.9 |
| 9 | Acidic | May 2019/June 2020 | 230 |
| 10 | Acidic | May 2019/June 2020 | 70 |
| 11 | Acidic | June 2019/June 2020 | 130 |
| 12 | Alkaline | July 2013/June 2020 | 150 |
| 13 | Alkaline | July 2013/September 2021 | 151.8 |
| 14 | Alkaline | April 2019/September 2021 | 30.5 |
| 15 | Alkaline | April 2019/September 2021 | 31.9 |
| 16 | Alkaline | July 2020/September 2021 | 26.4 |
| 17 | Alkaline | November 2020/September 2021 | 31.4 |
| 18 | Alkaline | May 2019/September 2021 | 29.2 |

*ppb = parts per billion

As shown in Table 24, the N-nitrosocytisine content in each cytisine drug substance was found to be less than 300 ppb (0.3 ppm).

The N-nitrosocytisine content data for the cytisine drug products (3.0 mg tablet, 1.5 mg tablet) is presented below:

TABLE 25
N-nitrosocytisine in Cytisinicline 3.0 mg fct

| | | N-nitrosocytisine in one |
|---|---|---|
| Batch | Primary packaging | tablet (ng) |
| 1 | PVC/PCTFE/AI | 62.4 |
| 1 | PVC/PE/PVDC/AI | 44.7 |
| 2 | PVC/PCTFE/AI | 80.0 |
| 2 | PVC/PE/PVDC/AI | 54.9 |
| 3 | PVC/PCTFE/AI | 93.0 |
| 3 | PVC/PE/PVDC/AI | 70.1 |
| 4 | PVC/PCTFE/AI | 37.0 |
| 4 | PVC/PE/PVDC/PE/PVC/AI | 33.2 |
| 5 | PVC/PE/PVDC/PE/PVC/AI | 4.1 |
| 5 | PVC/PE/PVDC/PE/PVC/AI | 2.8 |
| 6 | PVC/PE/PVDC/PE/PVC/AI | 7.9 |
| 7 | PVC/PCTFE/AI | 4.8 |
| 7 | PVC/PE/PVDC/PE/PVC/AI | 3.7 |
| 6 | PVC/PCTFE/AI | 6.1 |
| 8 | PVC/PCTFE/AI | 4.8 |
| 8 | PVC/PE/PVDC/PE/PVC/AI | 3.5 |

TABLE 26
N-Nitrosocytisine in Cytisinicline 1.5 mg fct.

| | | N-nitrosocytisine in one |
|---|---|---|
| Batch | Primary packaging | tablet (ng) |
| 9 | PVC/PCTFE/AI | 59.7 |
| 9 | PVC/PE/PVDC/AI | 33.1 |
| 9 | PVC/PE/PVDC/PE/PVC/AI | 64.8 |
| 10 | PVC/PE/PVDC/AI | 24.8 |
| 11 | PVC/PCTFE/AI | 26.5 |
| 11 | PVC/PE/PVDC/PE/PVC/AI | 27.2 |
| 4 | PVC/PE/PVDC/AI | 12.6 |
| 12 | PVC/PCTFE/AI | 14.1 |
| 12 | PVC/PE/PVDC/PE/PVC/AI | 15.4 |
| 13 | PVC/PCTFE/AI | 12.0 |
| 13 | PVC/PE/PVDC/PE/PVC/AI | 11.6 |

The results in Tables 25 and 26 show that all batches of cytisine drug products contain less than 100 ng N-nitrosocytisine per tablet.

Unless the context indicates otherwise, it is specifically intended that the various features of the invention described herein may be used in any combination. Moreover, the disclosure also contemplates that in some embodiments any feature or combination of features set forth herein may be excluded or omitted. To illustrate, if the specification states that a complex comprises components A, B, and C, it is specifically intended that any of A, B, or C, or a combination thereof, may be omitted and disclaimed singularly or in any combination.

Various embodiments of the present technology are set forth herein below in Paragraphs A-CCC.

Para A. A chromatographic method for detecting N-nitrosocytisine in a cytisine sample, the method comprising: (a) introducing the cytisine sample to a column comprising a stationary phase, wherein the cytisine sample comprises cytisine and is known to or suspected to comprise N-nitrosocytisine; (b) applying a first mobile phase comprising a first solution and a second solution in a volume ratio of about 90:10 to about 98:2 to the column such that N-nitrosocytisine, if any, is retained on the column; (c) eluting N-nitrosocytisine, if any, by applying to the column a second mobile phase comprising the first solution and the second solution in a volume ratio of about 75:25 to about 85:15, thereby forming an analyte; and (d) detecting N-nitrosocytisine, if any, in the analyte, wherein: the first solution comprises about 0.01% (v/v) to about 0.5% (v/v) of formic acid in water; and the second solution comprises about 0.01% (v/v) to about 0.5% (v/v) of formic acid in a mixture of about 40:60 (v/v) to about 60:40 (v/v) methanol and acetonitrile.

Para B. The chromatographic method of Para A, further comprising mixing the cytisine sample with a solvent prior to the introduction (a).

Para C. The chromatographic method of Para B, wherein the solvent is water and/or methanol.

Para D. The chromatographic method of any one of Paras A-C, wherein the first solution comprises 0.1% (v/v) formic acid in water.

Para E. The chromatographic method of any one of Paras A-D, wherein the second solution comprises 0.1% (v/v) formic acid in a mixture of 50:50 (v/v) methanol and acetonitrile.

Para F. The chromatographic method of any one of Paras A-E, wherein the first mobile phase comprises the first solution and the second solution in a volume ratio of about 95:5.

Para G. The chromatographic method of any one of Paras A-F, wherein the second mobile phase comprises the first solution and the second solution in a volume ratio of about 80:20.

Para H. The chromatographic method of any one of Paras A-G, wherein the first mobile phase is applied to the column for at least about 5 minutes in the application (b).

Para I. The chromatographic method of any one of Paras A-H, wherein the first mobile phase is applied to the column for about 10 minutes in the application (b).

Para J. The chromatographic method of any one of Paras A-I, wherein the second mobile phase is applied to the column for at least about 2 minutes after the application (b).

Para K. The chromatographic method of any one of Paras A-J, wherein the second mobile phase is applied to the column for about 5 minutes after the application (b).

Para L. The chromatographic method of any one of Paras A-K, wherein the column is a high-performance liquid chromatography (HPLC) column.

Para M. The chromatographic method of any one of Paras A-K, wherein the column is an ultra high-performance liquid chromatography (UPLC) column.

Para N. The chromatographic method of any one of Paras A-M, wherein the column is a pentafluorophenyl (PFP) column.

Para O. The chromatographic method of any one of Paras A-M, wherein the column is an octadecylsilyl-pentafluorophenyl (C18-PFP) column.

Para P. The chromatographic method of any one of Paras A-O, wherein the stationary phase has a length of about 150 mm, and an inner diameter of about 4.6 mm.

Para Q. The chromatographic method of any one of Paras A-O, wherein the stationary phase has a length of about 100 mm, and an inner diameter of about 3.0 mm.

Para R. The chromatographic method of any one of Paras A-Q, wherein the stationary phase comprises porous particles having a particle size of about 2.6 μm, and a pore size of about 100 Å.

Para S. The chromatographic method of any one of Paras A-Q, wherein the stationary phase comprises porous particles having a particle size of about 1.7 μm, and a pore size of about 100 Å.

Para T. The chromatographic method of any one of Paras A-S, wherein N-nitrosocytisine, if any, is ionized and directed to a mass spectrometer for the detection (d), wherein N-nitrosocytisine is ionized to one or more ions detectable by the mass spectrometer.

Para U. The chromatographic method of Para T, wherein N-nitrosocytisine, if any, is ionized by an electrospray ionization (ESI) source.

Para V. The chromatographic method of Para T, wherein N-nitrosocytisine, if any, is ionized by an atmospheric pressure chemical ionization (APCI) source.

Para W. The chromatographic method of Para T, wherein the mass spectrometer for the detection (d) is in positive ion mode.

Para X. The chromatographic method of Para W, wherein the N-nitrosocytisine is ionized to generate one or more positive ions with a mass-to-charge ratio (m/z) of about 220.11.

Para Y. The chromatographic method of Para W, wherein the N-nitrosocytisine is ionized to generate one or more positive ions with a mass-to-charge ratio (m/z) of 220.1081.

Para Z. The chromatographic method of any one of Paras T-Y, wherein the mass spectrometer for the detection (d) is a high-resolution mass spectrometer.

Para AA. The chromatographic method of any one of Paras A-Z, wherein N-nitrosocytisine, if any, is detected by quadrupole time-of-flight (Q-TOF) mass spectrometry.

Para BB. The chromatographic method of any one of Paras A-AA, wherein the cytisine sample is a drug substance.

Para CC. The chromatographic method of Para BB, wherein the cytisine sample is mixed with water prior to the introduction (a).

Para DD. The chromatographic method of any one of Paras A-AA, wherein the cytisine sample is a drug product that optionally comprises a pharmaceutically acceptable carrier and/or excipient.

Para EE. The chromatographic method of Para DD, wherein the drug product is in the form of tablet.

Para FF. The chromatographic method of Para EE, wherein each tablet comprises about 1.5 mg or about 3 mg cytisine.

Para GG. The chromatographic method of Para EE or FF, wherein the tablet is powdered, pulverized, crushed, or ground prior to the introduction (a).

Para HH. The chromatographic method of any one of Paras EE-GG, wherein the cytisine sample is mixed with water and/or methanol prior to the introduction (a).

Para II. The chromatographic method of any one of Paras A-HH, further comprising: subsequent to detecting the N-nitrosocytisine in the analyte, determining a content of N-nitrosocytisine in the cytisine sample via an external standard method.

Para JJ. The chromatographic method of any one of Paras A-HH, further comprising: subsequent to detecting the N-nitrosocytisine in the analyte, determining a content of N-nitrosocytisine in the cytisine sample via an internal standard method.

Para KK. The chromatographic method of Para JJ, wherein an isotope of N-nitrosocytisine is used as an internal standard of the internal standard method.

Para LL. The chromatographic method of Para KK, wherein the isotope of N-nitrosocytisine is N-nitrosocytisine-d4.

Para MM. An apparatus for carrying out the chromatographic method of any one of Paras A-LL.

Para NN. Use of a chromatographic method for detecting N-nitrosocytisine in a cytisine sample, comprising: (a) introducing the cytisine sample to the column the cytisine sample comprises cytisine and is known to or suspected to comprise N-nitrosocytisine; (b) applying a first mobile phase comprising a first solution and a second solution in a volume ratio of about 90:10 to about 98:2 to the column such that N-nitrosocytisine, if any, is retained on the column; (c) eluting N-nitrosocytisine, if any, by applying to the column a second mobile phase comprising the first solution and the second solution in a volume ratio of about 75:25 to about 85:15, thereby forming an analyte; and (d) detecting N-nitrosocytisine, if any, in the analyte, wherein: the first solution comprises about 0.01% (v/v) to about 0.5% (v/v) of formic acid in water; and the second solution comprises about 0.01% (v/v) to about 0.5% (v/v) of formic acid in a mixture of about 40:60 (v/v) to about 60:40 (v/v) methanol and acetonitrile.

Para OO. The use of Para NN, wherein the column is a high-performance liquid chromatography (HPLC) column.

Para. PP. The use of Para NN, wherein the column is an ultra high-performance liquid chromatography (UPLC) column.

Para QQ. The use of Para NN, wherein the column is a pentafluorophenyl (PFP) column.

Para RR. The use of Para NN, wherein the column is an octadecylsilyl-pentafluorophenyl (C18-PFP) column.

Para SS. The use of any one of Paras NN-RR, wherein the column comprises a stationary phase having a length of about 150 mm, and an inner diameter of about 4.6 mm.

Para TT. The use of any one of Paras NN-RR, wherein the column comprises a stationary phase having a length of about 100 mm, and an inner diameter of about 3.0 mm.

Para UU. The use of any one of Paras NN-TT, wherein the column comprises a stationary phase comprising porous particles having a particle size of about 2.6 μm, and a pore size of about 100 Å.

Para VV. The use of any one of Paras NN-TT, wherein the column comprises a stationary phase comprising porous particles having a particle size of about 1.7 μm, and a pore size of about 100 Å.

Para WW. The use of any one of Paras NN-WV, wherein the cytisine sample is a drug substance.

Para XX. The use of any one of Paras NN-WW, wherein the cytisine sample is mixed with water prior to the introduction (a).

Para YY. The use of any one of Paras NN-VV, wherein the cytisine sample is a drug product that optionally comprises a pharmaceutically acceptable carrier and/or excipient.

Para ZZ. The use of Para YY, wherein the drug product is in the form of a tablet.

Para AAA. The use of Para ZZ, wherein the tablet comprises about 1.5 mg or about 3 mg cytisine.

Para BBB. The use of Para ZZ, wherein the tablet is powdered, pulverized, crushed, or ground prior to the introduction (a).

Para CCC. The use of Para ZZ, wherein the cytisine sample is mixed with water and/or methanol prior to the introduction (a).

1. A chromatographic method for detecting N-nitrosocytisine in a cytisine sample, the method comprising:
(a) introducing the cytisine sample to a column comprising a stationary phase, wherein the cytisine sample comprises cytisine and is known to or suspected to comprise N-nitrosocytisine;
(b) applying a first mobile phase comprising a first solution and a second solution in a volume ratio of about 90:10 to about 98:2 to the column such that N-nitrosocytisine, if any, is retained on the column;
(c) eluting N-nitrosocytisine, if any, by applying to the column a second mobile phase comprising the first solution and the second solution in a volume ratio of about 75:25 to about 85:15, thereby forming an analyte; and
(d) detecting N-nitrosocytisine, if any, in the analyte,
wherein:
the first solution comprises about 0.01% (v/v) to about 0.5% (v/v) of formic acid in water; and
the second solution comprises about 0.01% (v/v) to about 0.5% (v/v) of formic acid in a mixture of about 40:60 (v/v) to about 60:40 (v/v) methanol and acetonitrile.

2. The chromatographic method of claim 1, further comprising mixing the cytisine sample with a solvent prior to the introduction (a).

3. The chromatographic method of claim 2, wherein the solvent is water and/or methanol.

4. The chromatographic method of claim 1, wherein the first solution comprises 0.1% (v/v) formic acid in water and the second solution comprises 0.1% (v/v) formic acid in a mixture of 50:50 (v/v) methanol and acetonitrile.

5. (canceled)

6. The chromatographic method of claim 1, wherein the first mobile phase comprises the first solution and the second solution in a volume ratio of about 95:5 and the second mobile phase comprises the first solution and the second solution in a volume ratio of about 80:20.

7. (canceled)

8. The chromatographic method of claim 1, wherein the first mobile phase is applied to the column for at least about 5 minutes in the application (b) and the second mobile phase is applied to the column for at least about 2 minutes after the application (b).

9-11. (canceled)

12. The chromatographic method of claim 1, wherein the column is a high-performance liquid chromatography (HPLC) column or an ultra high-performance liquid chromatography (UPLC) column.

13. (canceled)

14. The chromatographic method of claim 1, wherein the column is a pentafluorophenyl (PFP) column or an octadecylsilyl-pentafluorophenyl (C18-PFP) column.

15. (canceled)

16. The chromatographic method of claim 1, wherein the stationary phase has a length of about 100 mm to about 150 mm, and an inner diameter of about 3.0 mm to about 4.6 mm.

17. (canceled)

18. The chromatographic method of claim 1, wherein the stationary phase comprises porous particles having a particle size of about 1.7 μm to about 2.6 μm, and a pore size of about 100 Å.

19. (canceled)

20. The chromatographic method of claim 1, wherein N-nitrosocytisine, if any, is ionized and directed to a mass spectrometer for the detection (d), wherein N-nitrosocytisine is ionized to one or more ions detectable by the mass spectrometer.

21. The chromatographic method of claim 20, wherein N-nitrosocytisine, if any, is ionized by an electrospray ionization (ESI) source or an atmospheric pressure chemical ionization (APCI) source.

22. (canceled)

23. The chromatographic method of claim 20, wherein the mass spectrometer for the detection (d) is in positive ion mode.

24-25. (canceled)

26. The chromatographic method of claim 20, wherein the mass spectrometer for the detection (d) is a high-resolution mass spectrometer.

27. The chromatographic method of claim 1, wherein N-nitrosocytisine, if any, is detected by quadrupole time-of-flight (Q-TOF) mass spectrometry.

28. The chromatographic method of claim 1, wherein the cytisine sample is a drug substance.

29. (canceled)

30. The chromatographic method of claim 1, wherein the cytisine sample is a drug product that optionally comprises a pharmaceutically acceptable carrier and/or excipient.

31. The chromatographic method of claim 30, wherein the drug product is in the form of tablet and the tablet comprises about 1.5 mg or about 3 mg cytisine.

32. (canceled)

33. The chromatographic method of claim 31, wherein the tablet is powdered, pulverized, crushed, or ground and/or mixed with water and/or methanol prior to the introduction (a).

34-35. (canceled)

36. The chromatographic method of claim 1, further comprising:
subsequent to detecting the N-nitrosocytisine in the analyte, determining a content of N-nitrosocytisine in the cytisine sample via an internal standard method, wherein an isotope of N-nitrosocytisine is used as an internal standard of the internal standard method.

37-39. (canceled)
